(19) United States
(12) Patent Application Publication
(10) Pub. No.: US 2026/0288839 A1
(43) Pub. Date: Sep. 24, 2026

(54) SYSTEM

(71) Applicant: SoftBank Group Corp., Tokyo (JP)

(72) Inventor: Naoki EGAWA, Tokyo (JP)

(73) Assignee: SoftBank Group Corp., Tokyo (JP)

(21) Appl. No.: 19/567,260

(22) Filed: Mar. 16, 2026

(30) Foreign Application Priority Data
Mar. 19, 2025 (JP) 2025-045241

(51) Int. Cl. G06F 16/335

(52) U.S. Cl. CPC G06F 16/337

(57) ABSTRACT

A system includes a processor that is configured to provide an interface through which a user specifies a genre and an age, automatically generate a prompt sentence for instructing a generative AI model to generate a story based on the specified genre and the specified age, analyze a generated story by using an emotion engine that recognizes an emotion of the user, and adjust the story based on the recognized emotion.

### CROSS-REFERENCE TO RELATED APPLICATION

This application is based on and claims priority under 35 USC 119 from Japanese Patent Application No. 2025-045241 filed on Mar. 19, 2025, the disclosure of which is incorporated by reference herein.

### BACKGROUND

### Technical Field

The Present Disclosure Relates to a System.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional content generation systems using generative AI models typically generate stories solely on the basis of static input conditions such as a selected genre and a target age group. In such systems, once the input parameters are specified and a story is generated, the story content does not adapt to changes in a user's emotional state during reading or interaction. As a result, the generated story may fail to maintain the user's engagement, may not provide a personalized emotional experience, and may even present content that is mismatched with, or undesirable for, the user's current emotional condition.

Furthermore, known systems generally do not include a mechanism for automatically generating appropriate prompts for generative AI models in response to user-specified genre and age, nor do they integrate an emotion recognition engine that analyzes user emotions and dynamically adjusts the story content accordingly. In particular, there is insufficient support for picture-book style content in which themes and characters are automatically selected and adapted based not only on genre and age but also on the user's recognized emotions.

Therefore, there is a need for a system that can generate and iteratively adjust story content by tightly coupling user input parameters, generative AI models, and emotion-based feedback so as to provide a personalized and emotionally responsive story experience.

### SUMMARY

To solve the above-described problems, the invention provides a system comprising a processor, wherein the processor is configured to provide an interface through which a user specifies a genre and an age, automatically generate a prompt sentence for instructing a generative AI model to generate a story based on the specified genre and the specified age, and analyze a generated story by using an emotion engine that recognizes an emotion of the user and adjust the story based on the recognized emotion.

In one embodiment, the processor is configured to cause the emotion engine to reconfigure elements of the story so that the generated story dynamically changes in accordance with the emotion of the user. For example, when the emotion engine recognizes that the user is anxious or bored, the processor can modify story elements such as events, pacing, or tone to make the story more comforting, exciting, or engaging, thereby maintaining an appropriate emotional balance for the user.

In another embodiment, the processor is configured to automatically select a picture book theme and one or more characters based on the specified genre, the specified age, and the recognized emotion, and to reflect the selected picture book theme and the one or more characters in the story generated by the generative AI model. By doing so, the system can generate a story in which the overall theme, the nature of the characters, and their behaviors are adapted not only to the developmental stage indicated by the age but also to the emotional state recognized by the emotion engine. As a result, the system enables dynamic and iterative story generation that delivers a personalized and emotionally aligned picture-book experience to the user.

The term “processor” refers to one or more hardware processing units, such as a CPU, GPU, microprocessor, or a combination thereof, and may further include associated memory and circuitry configured to execute instructions for implementing the functions described in the claims.

The term “interface” refers to a hardware and/or software component that allows a user to input information, including at least a genre and an age, and to receive output information, such as a generated story, through a graphical user interface, a command-line interface, a touchscreen, voice input, or any other input/output mechanism.

The term “genre” refers to a classification or category of a story, such as adventure, fantasy, mystery, or other thematic or stylistic categories, which is used as a parameter for generating and adjusting story content.

The term “age” refers to a value representing a target age group or developmental stage of an intended reader or user, and is used as a parameter for controlling the complexity, vocabulary, structure, and themes of the generated story.

The term “prompt sentence” refers to a text string or set of textual instructions that is automatically generated based on at least the specified genre and the specified age, and that is supplied to a generative AI model to cause the generative AI model to generate a story.

The term “generative AI model” refers to a machine learning model, such as a neural network-based language model, that is configured to generate story text or other content in response to input data including a prompt sentence.

The term “story” refers to a sequence of text representing a narrative, including at least one of a plot, a setting, one or more characters, and events, and may be formatted in a picture-book style or in other narrative formats.

The term “emotion engine” refers to a hardware and/or software module configured to recognize, estimate, or infer a user's emotion based on at least one type of input, such as facial expressions, voice, physiological signals, interaction behavior, or textual feedback, and to output information representing the recognized emotion.

The term “emotion of the user” refers to an emotional state or affective condition of a user, such as happiness, sadness, fear, excitement, boredom, or calmness, as recognized or inferred by the emotion engine.

The term “analyze a generated story” refers to processing the content of the story, in association with information from the emotion engine, to determine how the story may be modified, adjusted, or reconfigured to better align with the recognized emotion of the user.

The term “adjust the story” refers to modifying at least part of the story content based on the recognized emotion, including changing one or more narrative elements such as events, wording, pacing, tone, or outcome so as to influence or respond to the user's emotional state.

The term “reconfigure elements of the story” refers to altering, adding, removing, or rearranging individual narrative elements of the story, such as characters, scenes, events, or dialogues, under control of the emotion engine and/or the processor.

The term “dynamically changes” refers to the property that the story content is modified during generation or after initial generation in response to changes in the recognized emotion of the user, so that different story versions can be produced over time for the same or similar input conditions.

The term “picture book theme” refers to a conceptual subject or motif suitable for picture books, including but not limited to topics such as friendship, adventure, learning, or family, which guides the overall narrative structure and mood of the generated story.

The term “character” refers to an entity appearing in the story, such as a person, animal, imaginary creature, or anthropomorphized object, that participates in the narrative and may have associated attributes such as name, personality traits, and roles.

The term “reflect in the story” refers to incorporating selected themes, characters, or other narrative elements into the content generated by the generative AI model such that these elements appear explicitly or implicitly in the resulting story text.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

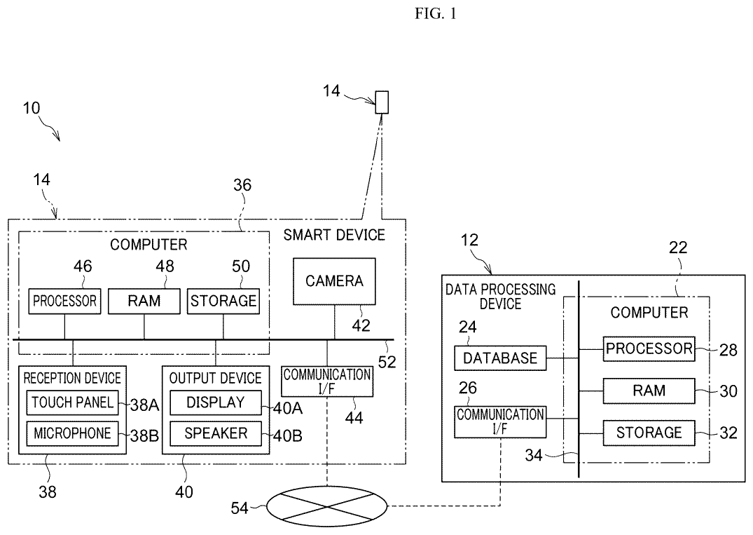

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

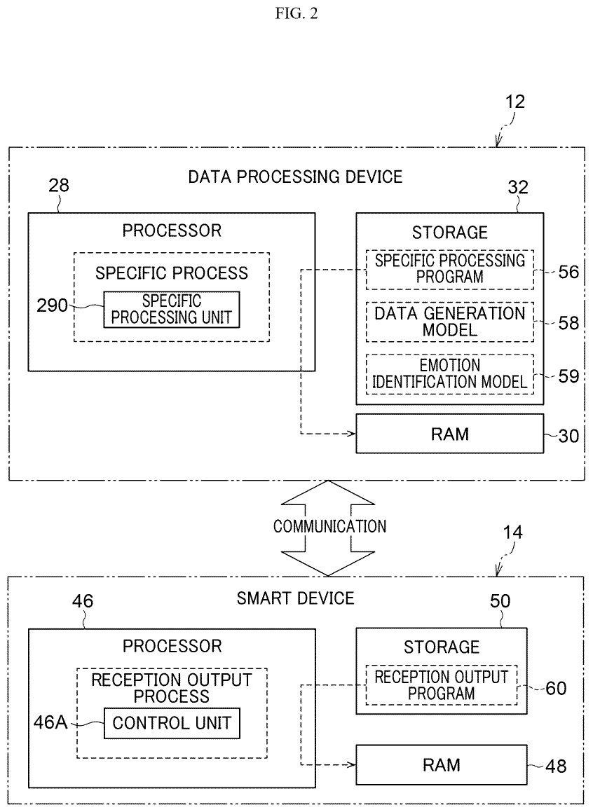

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples.

Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60.

The reception and output processing is implemented by the processor 46 operating as the control unit 46A according to the reception and output program 60 executed in the RAM 48.

Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58.

The data processing device 12 may be a server device, and may be a terminal device owned by the user (for example, a mobile phone, a robot, a home electrical appliance, or the like).

Next, description follows regarding an example of processing by the data processing system 10 according to the first exemplary embodiment.

### Example 1

Description follows regarding a flow of the specific processing in an Example 1.

The units of the system described below are implemented by the data processing device 12 and the smart device 14. The data processing device 12 is called a “server” and the smart device 14 is called a “terminal”.

Conventional content generation systems that utilize generative AI models generally accept simple, static parameters such as a topic or keyword, and then return a fixed piece of generated text. Such systems have several technical limitations when viewed as computer-implemented information processing technology.

First, traditional systems do not formally integrate structured user profile information, such as a content category and a target age range, into a systematic prompt construction pipeline. In many implementations, an application simply concatenates user-supplied strings into a prompt in an ad hoc manner. This leads to prompts that are not consistently machine-interpretable and that do not fully exploit the generative AI model's capabilities. As a result, the generated content often fails to match the user's developmental stage or intended genre, and the underlying computation on the server side is not optimized for reliably conditioning the generative model.

Second, conventional systems typically treat the output of a generative AI model as final text, and do not provide a feedback loop based on user-specific real-time signals. In particular, the system does not use a dedicated emotion estimation processing unit to analyze generated content in view of a user's emotional state, nor does it perform structured, machine-controlled reconfiguration of story components in response to changing emotional conditions.

From a system perspective, the server does not maintain a dynamic control mechanism that iteratively adjusts content data based on emotion estimation results, and therefore cannot adapt story structure, events, and characters to maintain user engagement or comfort.

Third, user interfaces in known systems are generally limited to issuing a single content request and displaying a static result. The UI logic is not tightly coupled with a back-end workflow that (i) receives structured selection information (content category, target age range), (ii) transforms it into a normalized condition information set, (iii) constructs a natural-language prompt sentence using deterministic string processing, and (iv) coordinates multi-stage processing, including generative AI inference and subsequent emotion-based restructuring of the generated content. This fragmented approach results in inefficiencies in server processing, difficulty in scaling and monitoring prompt behavior, and a lack of consistent control over the entire content generation and adaptation pipeline.

Therefore, there is a need for an improved computer-implemented system and method that: (1) acquires structured user selection information via a terminal in a controlled manner; (2) generates a well-defined prompt sentence in natural language by performing systematic character string processing based on condition information including a content category and a target age range; (3) invokes a generative AI model to compute content data based on the prompt sentence; and (4) feeds the generated content data into an emotion estimation processing unit, which allows a processor to dynamically adjust story components or expression formats, and to retransmit the adjusted content data to a terminal for visual presentation. Such a system should enhance the technical operation of server-side content generation by providing an integrated, programmable pipeline for prompt generation, model invocation, and emotion-based post-processing, thereby improving the quality, adaptability, and controllability of machine-generated stories in a networked environment.

The specific processing by the specific processing unit 290 of the data processing device 12 in Example 1 is realized by the following means.

The present invention provides a server comprising a processor configured to control a display device and an input device of a terminal so that a user is enabled to select at least one content category and at least one target age range from among a plurality of content categories and a plurality of target age ranges, to receive, via a communication network, request information including selection information corresponding to the selected content category and the selected target age range, to extract, from the request information, condition information including the content category and the target age range, to automatically generate, by performing character string processing on the condition information, a prompt sentence expressed in natural language, to input the automatically generated prompt sentence into a generative information processing model and cause the generative information processing model to generate content data including story information by performing probabilistic calculation processing based on the prompt sentence, to input the generated content data into an emotion estimation processing unit that estimates an emotional state of the user, to perform content adjustment processing for changing story components or an expression format within the content data on the basis of an emotion estimation result obtained by the emotion estimation processing unit, and to transmit the content data after the content adjustment processing to the terminal via the communication network so that the terminal outputs the content data after the content adjustment processing in a format visually presentable to the user. This enables an integrated computer-implemented pipeline in which structured user selection information is transformed into a natural-language prompt sentence, the generative AI model is deterministically controlled based on the prompt sentence, and the generated content is dynamically reconfigured according to the user's emotional state, thereby improving the technical operation, adaptability, and controllability of network-based content generation systems.

The term “processor” refers to a hardware-based information processing unit, such as a central processing unit or an arithmetic and logic unit, that executes program instructions to perform control, computation, and data processing operations in the system.

The term “terminal” refers to an information processing apparatus, such as a client device, that includes at least a display device, an input device, and a communication interface, and that communicates with the server via a communication network.

The term “display device” refers to an output apparatus that presents visual information to a user, such as a screen, monitor, or other visual display unit capable of rendering text and graphics.

The term “input device” refers to an apparatus that detects user operations and converts the operations into input signals, such as a touch panel, keyboard, pointing device, or sensor-based input interface.

The term “content category” refers to a classification of content type or theme, selected from a plurality of predefined categories, and used as part of condition information for controlling content generation.

The term “target age range” refers to an indication of an age group or developmental stage of an intended audience, selected from a plurality of predefined ranges, and used to condition the generation and adjustment of content.

The term “selection information” refers to data representing one or more content categories and one or more target age ranges that have been specified by a user through the input device.

The term “request information” refers to data transmitted from the terminal to the server via a communication network, the data including at least selection information and optionally additional parameters used for content generation.

The term “condition information” refers to structured data extracted from the request information, the structured data including at least a content category and a target age range, and optionally other parameters used as a basis for generating a prompt sentence.

The term “character string processing” refers to computational processing performed on textual data, including at least concatenation, replacement, insertion, formatting, and other operations that transform structured data into natural-language text.

The term “prompt sentence” refers to a text sequence expressed in natural language, automatically generated based on condition information, and used as an input instruction for controlling behavior of a generative information processing model.

The term “generative information processing model” refers to a parameterized computational model, such as a neural network model, that receives a prompt sentence as input and generates new content data by performing probabilistic inference or similar statistical computation.

The term “probabilistic calculation processing” refers to numerical operations in which a generative information processing model computes probability distributions over candidate outputs and selects or samples outputs based on the probability distributions.

The term “content data” refers to digital data generated by the generative information processing model, including at least story information and optionally additional descriptive or structural information, which is suitable for presentation to a user.

The term “story information” refers to a subset of content data that represents a narrative structure, including at least characters, events, and a development order, expressed in a machine-readable or human-readable form.

The term “emotion estimation processing unit” refers to a functional module implemented by hardware and software that receives data associated with a user and/or content data, analyzes the data using an emotion recognition algorithm, and outputs an estimation of the user's emotional state.

The term “emotional state” refers to an internal condition of a user, such as happiness, sadness, fear, or excitement, represented in a machine-interpretable form, for example as labels, scores, or vectors.

The term “emotion estimation result” refers to data output by the emotion estimation processing unit that represents an estimated emotional state of the user at a given point in time.

The term “content adjustment processing” refers to processing in which the processor modifies at least part of the content data, including story components or expression formats, on the basis of an emotion estimation result, so as to adapt the content to the user's emotional state.

The term “story components” refers to constituent elements of story information, including at least characters, events, settings, narrative viewpoints, and a development order, which can be modified or reordered by processing.

The term “expression format” refers to a manner in which content data is expressed or presented, including at least wording, sentence complexity, paragraph structure, and presentation style.

The term “development order” refers to a sequence in which events, scenes, or narrative segments are arranged within the story information.

The term “illustrative information” refers to visual or descriptive information associated with the story, including at least subjects, backgrounds, and visual motifs, which can be used for generating or presenting illustrations or pictorial content.

The term “subject of illustrative information” refers to a main object, character, or scene that forms a central theme of illustrative information associated with the story.

The term “attribute information of characters” refers to data describing characteristics of story characters, including at least type, role, appearance, personality, or other features, that can be used in story generation and illustration selection.

The term “communication network” refers to a wired or wireless data transfer infrastructure, including at least the Internet, local area networks, or mobile communication networks, through which the terminal and the server exchange data.

The term “visually presentable format” refers to a data format that can be rendered by a display device to be visually perceivable by a user, including at least plain text, formatted text, images, or graphical structures.

In one embodiment, a server cooperates with a plurality of terminals operated by users via a communication network to implement the claimed system. The server includes at least one processor, a main memory, a non-volatile storage device, a network interface, and, in some variants, a graphics processing unit. The server executes an operating system such as a general-purpose server operating system and runs application software including a web application framework or an application server, a generative AI model serving module implemented for example with a neural network library such as a tensor-based numerical computation framework, and an emotion estimation processing unit. The terminal includes at least one processor, a display device such as a liquid crystal display or an organic light emitting display, an input device such as a touch panel, and a communication interface such as a wireless transceiver.

The terminal provides a graphical user interface that enables a user to select a content category and a target age range. The terminal executes client-side software, for example a web browser rendering an HTML5/JavaScript user interface or a native application implemented using a mobile application framework. The terminal displays, on the display device, a plurality of selectable items representing content categories and target age ranges and receives user operations through the input device. The terminal converts touch events or other user interactions into selection information in a structured internal format, such as a key-value mapping between a category identifier and a selected value or between an age-range identifier and a selected value, and stores the selection information in terminal memory.

The server receives request information from the terminal via the communication network.

The server uses the network interface and protocol stack to accept transmission control protocol packets and reconstructs application layer messages such as hypertext transfer protocol requests that encapsulate the selection information. The server parses the received messages and extracts condition information including at least one content category and at least one target age range. The server stores the condition information in main memory using an internal data structure such as a record or object with fields representing the category, the age, and optional parameters such as desired length or tone.

The server generates a prompt sentence in natural language from the condition information by character string processing. The server uses a string templating component that applies deterministic rules to insert the content category and the target age range into predefined textual templates. The server, for example, selects a base template for a story and concatenates phrases while enforcing grammatical constraints and inserting age-appropriate qualifiers. The server can generate, for instance, the following prompt sentences as concrete examples:
“Please create an adventure story suitable for a 5-year-old child. Use simple and friendly language, and keep the story short.”
“Please create a very short fantasy story suitable for a 3-year-old child. Use very simple sentences, kind characters, and avoid anything scary.”
“Please create an educational science story suitable for a 7-year-old child that explains how rainbows are formed in a fun and easy-to-understand way.”

The server stores the prompt sentence as a sequence of characters and also encodes it into tokens using a tokenizer consistent with a generative AI model deployed on the server or accessible via the network. The server thus transforms structured condition information into text and further into token identifiers suitable for neural network processing.

The server invokes a generative AI model to produce content data including story information. In one embodiment, the generative AI model is implemented as a transformer-based neural network including multiple layers of self-attention modules and feed-forward networks. The server loads trained model parameters from the storage device into main memory and, if available, into graphics processing unit memory. The server then performs forward propagation by applying linear transformations and non-linear activation functions to the token embeddings derived from the prompt sentence. The server computes, in each layer, attention scores between tokens, normalizes them using softmax functions, and applies the resulting attention weights to combine representations across positions. The server calculates probability distributions over vocabulary tokens at each generation step and selects or samples next tokens under predetermined decoding conditions such as temperature or top-k constraints.

The server configures the generative AI model with a loss function and learning algorithm during an offline training phase. The server can use, for example, a cross-entropy loss between predicted token distributions and ground truth tokens and can update model weights by stochastic gradient descent or an adaptive optimizer. During training, the server forwards token sequences through the network, computes gradients by backpropagation, and updates the parameters to minimize prediction error. The server may apply data augmentation methods such as random masking, random sentence order variation within narrative constraints, or synthetic label generation for emotional tone to improve generalization and stability. After training, the server uses the fixed parameters for inference when generating content based on prompt sentences.

The server generates content data in the form of a sequence of tokens that it decodes back into characters and sentences to produce story information. The server optionally adds structural metadata such as paragraph boundaries, character lists, and event markers. The server organizes the content data into an internal data structure including fields for narrative text, character descriptors, and event sequences.

The server applies an emotion estimation processing unit to analyze and adjust the content data. In one embodiment, the emotion estimation processing unit is implemented as another neural network, for example a bidirectional recurrent network or transformer fine-tuned for emotion classification, that takes as input the story text and, optionally, user interaction metrics such as reading speed or scroll behavior. The server transforms the story text into token embeddings and computes, via the emotion estimation network, a vector representation of emotional tone. The server outputs an emotion estimation result consisting of scores on multiple emotional dimensions such as joy, fear, sadness, and calmness.

The server uses the emotion estimation result to perform content adjustment processing. The server maps the emotion scores onto control parameters that guide the restructuring of story components. For instance, the server defines threshold rules indicating that, if a fear score exceeds a specified value for early paragraphs of a story intended for a young age range, then the server reduces or removes threatening events by substituting less intense events or by reordering scenes so that comforting resolutions appear earlier. The server modifies the story components by:
changing characters, for example replacing a frightening antagonist with a neutral or friendly character;
adjusting events, for example simplifying conflict intensity or removing scenes with high emotional load; and
altering development order, for example moving reassurance events to precede potentially disturbing events.

The server can implement such adjustments with rule-based operations on the structured story representation and, optionally, by issuing additional prompt sentences to the generative AI model that instruct it to rewrite specific segments under constraints derived from the emotion estimation result. In such a case, the server generates auxiliary prompt sentences such as: “Rewrite the following paragraph so that it is suitable for a 3-year-old child and does not contain any frightening elements, while keeping the main characters and the happy ending.”

The server combines deterministic adjustment rules with constrained regeneration by the generative AI model to achieve a controlled modification process.

The server transmits the adjusted content data to the terminal. The server formats the adjusted story information into a representation suitable for display, for example plain text with paragraph separators, and encapsulates it in a response message. The server sends the response to the terminal through the communication network using the network interface and protocol stack. The terminal receives the response, extracts the content data, and displays the story information on the display device.

The server thus improves computer technology beyond mere automation of human storytelling. By structuring the data flow from user selections into condition information, by transforming that information via deterministic string processing into a prompt sentence, by encoding the prompt sentence into tokens and processing them through a transformer-based generative AI model, and by feeding back the generated content into a separate emotion estimation processing unit and an adjustment module, the server achieves technical effects such as improved control over content generation, reduced need for repeated full-model invocations, and more efficient use of network and computational resources. The server can, for example, adjust only specific paragraphs based on emotion estimation results rather than regenerating entire stories, which reduces computation time and token usage. The server also enhances accuracy of age-appropriate content generation by encoding age and category information in a consistent prompt structure and by dynamically correcting deviations using emotion-based adjustments.

The server achieves improved data management by maintaining structured representations of condition information, prompt sentences, token sequences, story components, and emotion scores in memory. The server can index and log these units of information to monitor and refine prompt templates and adjustment rules. The modular architecture, in which the terminal, prompt-generation module, generative model module, emotion estimation unit, and content adjustment module are clearly separated, allows independent optimization of each component, leading to improved scalability and reliability of the overall system.

The server also provides alternative embodiments. In one variant, the terminal runs a native application that locally implements preliminary filtering of content based on simple rules prior to requesting detailed adjustment from the server, thereby reducing bandwidth usage by limiting the number of full stories requested. In another variant, the server deploys multiple generative AI models with different sizes and capabilities and selects, based on condition information, a model that balances latency and quality. For example, the server may use a smaller model for very short stories and a larger model for long educational narratives. In a further variant, the emotion estimation processing unit incorporates additional features such as user biometric signals from sensors connected to the terminal, and the server adjusts weights in the emotion estimation model via incremental learning to adapt to individual user profiles, while maintaining constraints to prevent overfitting.

The terminal can be implemented as a mobile device, a tablet, a desktop computer, or a smart display, and the server can be implemented as a single physical machine or a distributed system across multiple computing nodes. In each case, the server, the terminal, and the user cooperate such that the user provides selection input, the terminal transmits and displays content, and the server performs specialized processing including prompt sentence generation, generative AI model execution, emotion estimation, and structured content adjustment, thereby realizing the claimed system in concrete technical form.

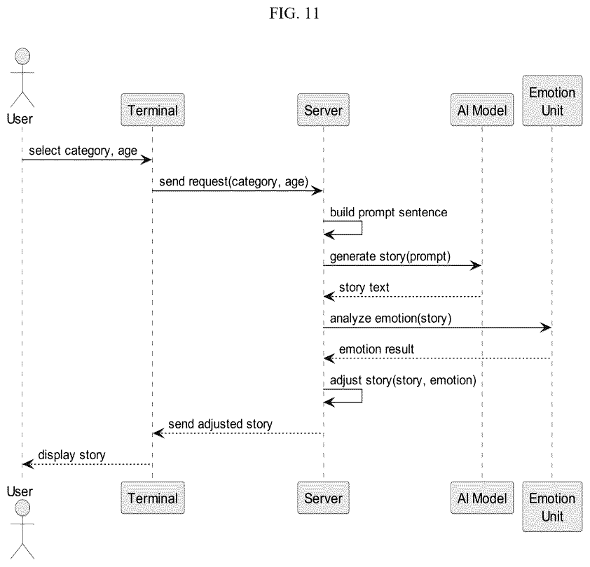

The following describes the processing flow using FIG. 11.

### Step 1:

User operates the terminal to select a content category and a target age range.
User views, on the terminal display, a list of selectable content categories and target age ranges rendered by a graphical user interface. User taps or clicks UI components such as dropdown lists, radio buttons, or selection tiles to choose one content category (for example, adventure, fantasy, or science) and one target age range (for example, 3, 5, or 7).
Input: visual options presented on the terminal interface.
Output: a pair of logical selection values representing the chosen content category and target age range.

### Step 2:

Terminal converts the user's selections into structured selection information.
Terminal executes client-side code that reads the current state of the UI components and maps the selected items to internal identifiers. Terminal constructs a structured data object, such as a key-value mapping with fields for category and age range, and stores it in working memory.
Input: the selected content category and target age range from the UI components.
Output: structured selection information including at least a category identifier and a target age identifier.

### Step 3:

Terminal generates request information and transmits it to the server.
Terminal serializes the structured selection information into a string-based representation, for example a text-encoded parameter set in a message body, and attaches it to a request message. Terminal uses a communication interface and protocol stack to encapsulate the request information in a network packet and sends it to a designated server endpoint via a communication network.
Input: structured selection information.
Output: request information transmitted over the network, including the selection information in a machine-readable format.

### Step 4:

Server receives the request information and extracts condition information.
Server uses a network interface to accept incoming packets and reconstruct the request message. Server parses the message content using a parser corresponding to the chosen message format and locates fields representing the content category and target age range.
Server converts these fields into internal variables and stores them in main memory as condition information.
Input: request information containing selection information from the terminal.
Output: condition information including at least one content category value and one target age range value.

### Step 5:

Server generates a prompt sentence in natural language based on the condition information.
Server applies character string processing to a predefined template, inserting the content category and target age range values into specific placeholders. Server may adjust word choice and sentence length according to the age range, and may append constraints related to tone or complexity. Through concatenation, substitution, and formatting operations, the server transforms the symbolic condition information into a grammatically correct prompt sentence. Example outputs of this processing include: “Please create an adventure story suitable for a 5-year-old child. Use simple and friendly language, and keep the story short.” and “Please create a very short fantasy story suitable for a 3-year-old child. Use very simple sentences, kind characters, and avoid anything scary.”
Input: condition information including the content category and target age range.
Output: a prompt sentence expressed in natural language, encoded as a character string.

### Step 6:

Server converts the prompt sentence into tokens suitable for input to the generative AI model.
Server invokes a tokenizer associated with the generative AI model to segment the prompt sentence into subword or word units. Server maps each unit to a numerical token identifier using a predefined vocabulary table stored in memory. Server then constructs an ordered sequence of token identifiers and, optionally, corresponding embedding vectors if preprocessing is handled on the server side.
Input: prompt sentence as a character string.
Output: a sequence of token identifiers and, in some configurations, token embeddings representing the prompt sentence.

### Step 7:

Server executes the generative AI model to generate content data including story information.
Server feeds the sequence of token identifiers into a generative AI model implemented as a multi-layer neural network, such as a transformer model with self-attention and feed-forward layers. Server performs a series of matrix multiplications and non-linear activation operations on the token embeddings, layer by layer, computing probability distributions over output tokens at each time step. Based on these distributions and decoding parameters such as temperature and top-k or top-p thresholds, server selects or samples next tokens to extend the output sequence until a termination condition is met.
Input: sequence of token identifiers representing the prompt sentence.
Output: a generated token sequence that encodes content data, including at least narrative story information.

### Step 8:

Server decodes the generated token sequence into story text and organizes story components.
Server maps each generated token identifier back to a corresponding text fragment using the model's vocabulary, concatenating the fragments to produce a coherent character string.
Server then analyzes the resulting text to identify structural units such as paragraphs, sentences, character names, and key events, and stores them in a structured data representation of the story.
Input: generated token sequence from the generative AI model.
Output: story text as a character string and structured story components comprising characters, events, and narrative segments.

### Step 9:

Server estimates an emotional state using the story text and optional user-related data.
Server passes the story text, and optionally user interaction signals if available, to an emotion estimation processing unit. Server tokenizes the text again using an emotion-model tokenizer and converts it into embeddings. Server processes these embeddings through an emotion estimation network, such as a classifier with multiple layers, to compute numerical scores for a set of predefined emotion categories. Server interprets these scores as an emotion estimation result indicating the likely emotional impact or tone of the story for the intended age range.
Input: story text and optional user-related signals.
Output: an emotion estimation result comprising one or more emotion scores or labels.

### Step 10:

Server determines adjustment parameters for the story based on the emotion estimation result and the condition information.
Server compares the emotion scores to target ranges associated with the content category and age range. Server applies decision rules, thresholds, or a mapping function to convert deviations between observed and target emotional profiles into adjustment parameters. These parameters can indicate, for example, a reduction of fearful elements, an increase in positive or calming elements, or an adjustment of narrative pacing.
Input: emotion estimation result and condition information.
Output: adjustment parameters specifying how story components or expression formats should be modified.

### Step 11:

Server adjusts story components and expression format according to the adjustment parameters.
Server operates on the structured representation of the story components to perform concrete modifications. Server may delete or replace events that exceed allowed intensity, reorder scenes to move reassuring outcomes earlier, and alter character roles to reduce conflict or threat. Server edits the wording of sentences to simplify or soften expressions in accordance with the target age range. During this process, server may generate auxiliary prompt sentences that instruct the generative AI model to rewrite specified segments under constraints, and server merges the rewritten segments back into the overall story structure.
Input: structured story components and adjustment parameters.
Output: adjusted content data including revised story components and an updated story text that better matches the desired emotional profile.

### Step 12:

Server formats the adjusted content data for delivery to the terminal.
Server takes the adjusted story text and applies formatting rules, such as inserting line breaks, marking paragraph boundaries, or adding simple headings, to produce a visually coherent text representation. Server encapsulates the formatted text and any associated metadata into a response message using a predefined data layout.
Input: adjusted content data including revised story text and structure.
Output: a formatted content payload ready for transmission to the terminal.

### Step 13:

Server transmits the formatted content payload to the terminal via the communication network.
Server uses its network interface and communication protocol stack to package the formatted payload into one or more response messages. Server addresses the messages to the terminal's network address and sends them over the communication network.
Input: formatted content payload.
Output: one or more response messages delivered to the terminal containing the adjusted story.

### Step 14:

Terminal receives the response messages and reconstructs the content payload.
Terminal's communication interface accepts incoming messages and passes them to client-side software. Terminal reassembles message segments if necessary and extracts the formatted content payload from the response. Terminal parses the payload according to the expected data structure and retrieves the story text and related presentation information.
Input: response messages from the server.
Output: reconstructed content payload including the adjusted story text and formatting information.

### Step 15:

Terminal renders the adjusted story text on the display device for the user.
Terminal applies rendering logic to map paragraph markers, line breaks, and other formatting instructions to visual elements on the display. Terminal updates the graphical user interface to show the new story text, scrollable or paginated as appropriate, and adjusts font size and layout according to device characteristics.
Input: reconstructed content payload from the server.
Output: visual presentation of the adjusted story on the display device, allowing the user to read and interact with the generated content.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional content delivery systems that personalize content based on user attributes such as genre preference and age group typically rely on fixed templates or pre-authored libraries. Even when a generative AI model is introduced, these systems often submit only a simple, static prompt to the model and then display the entire generated result as-is. As a consequence, the system cannot effectively adapt the generated content in real time to the user's changing emotional state, cannot efficiently reuse structured user inputs to generate high-quality prompt sentences, and cannot provide a smooth interactive experience in which content is streamed, adjusted, and regenerated in response to ongoing user interaction.

From a computer technology perspective, such conventional systems suffer from several technical limitations. First, they do not structure user selection data into machine-friendly formats for systematic prompt construction, resulting in ad-hoc string concatenation that is difficult to control, optimize, or extend. Second, they treat the generative AI model as a black-box text generator without an integrated post-processing pipeline; thus, there is no mechanism in the system architecture for structured filtering, formatting, or recomposition of the generated character information sequence on the server side. Third, they lack a feedback loop that uses automatically estimated user state information, such as emotional state, to reconfigure core story elements (e.g., appearing entities, scene settings, story developments) and to regenerate prompts in a manner that dynamically changes the generated content while it is being presented. Fourth, content delivery is usually performed in batch mode only, which leads to higher latency and prevents the system from providing streaming-based progressive display that can mask generation latency and allow in-session adaptation.

Therefore, there is a need for an improved computer-implemented system that (i) acquires user-selected information categories and age groups through a structured interface, (ii) converts these inputs into structured data and uses them to automatically generate well-formed natural-language prompt sentences, (iii) interacts with a generative AI model in a streaming or batch manner while performing server-side post-processing of generated character information, (iv) incorporates an emotion estimation processing unit that analyzes user state information and dynamically adjusts the generated content by adding, deleting, or modifying constituent elements, and (v) supports regeneration and condition-change operations in a closed feedback loop. Such a system can improve the overall operation of the computer by enhancing control over generative AI invocation, reducing perceived latency through streaming, and enabling real-time adaptive content generation tightly integrated with user interaction.

The specific processing by the specific processing unit 290 of the data processing device 12 in Application Example 1 is realized by the following means.

The present invention provides a server comprising a processor configured to provide, to a user via a display unit and an operation unit of an information processing terminal, a user input/output interface that enables the user to select and input an information category and an age group; convert the information category and the age group acquired from the user input/output interface into a structured data format, automatically generate, on the basis of the structured data, a natural-language prompt sentence corresponding to the information category and the age group, and transmit the prompt sentence to a generative AI model included in a generative information processing model disposed internally or externally to the server; receive, from the generative AI model, a character information sequence output in response to the prompt sentence in a sequential or batch manner, and perform post-processing on the character information sequence, the post-processing including at least one of formatting, phrase filtering, and segmentation/combination, so as to shape the character information sequence into visual-presentation information; transmit the visual-presentation information, by a streaming scheme or a batch scheme, to a visual display apparatus including at least one of a portable information terminal and a wearable display device, and cause the visual display apparatus to sequentially display the visual-presentation information; receive, via the visual display apparatus, a regeneration instruction or a condition-change instruction from the user who has visually recognized the visual-presentation information, and, in response to the regeneration instruction or the condition-change instruction, re-execute automatic generation of the prompt sentence and transmission of the prompt sentence to the generative AI model; and analyze the character information sequence output from the generative AI model by using an emotion estimation processing unit that changes the character information sequence on the basis of state information of the user, and, in accordance with the state information, selectively add, delete, or modify constituent elements of the character information sequence so as to adjust the visual-presentation information. This enables an improvement in computer functionality by providing a structured, server-centric pipeline that transforms user selections into controlled prompt sentences, integrates streaming interaction with the generative AI model, and dynamically adapts generated content based on automatically estimated user state information, thereby reducing perceived latency, enhancing controllability of generated outputs, and realizing real-time, feedback-driven content generation and presentation.

The term “processor” refers to a hardware or virtual computation unit, such as a central processing unit or an execution core in a computing environment, that executes instructions to implement the functions described in the claims.

The term “user” refers to a human operator who interacts with the system through an information processing terminal and consumes content generated and presented by the system.

The term “information processing terminal” refers to an electronic apparatus, such as a mobile device, tablet device, personal computer, or head-mounted device, that includes at least a display unit and an operation unit and that communicates with the server.

The term “display unit” refers to a visual output component of the information processing terminal, such as a liquid crystal display, organic electroluminescent display, or head-mounted display, that presents visual-presentation information to the user.

The term “operation unit” refers to an input component of the information processing terminal, such as a touch panel, physical button, pointing device, or gesture sensor, that acquires operation information from the user.

The term “user input/output interface” refers to a software and hardware combination that presents selection controls or display elements to the user and receives user input, including selection of an information category and an age group, via the display unit and the operation unit.

The term “information category” refers to a classification identifier indicating a type or theme of content to be generated, such as adventure, fantasy, science-related content, or other content classes, used as a condition for content generation.

The term “age group” refers to a range or level of user age, represented as numerical or categorical data, that is used to determine suitability, complexity, and style of the generated content.

The term “structured data format” refers to a machine-readable representation of data, such as a key-value structure, array, or object format, including but not limited to formats equivalent to JSON or XML, that encodes the information category and the age group for systematic processing.

The term “prompt sentence” refers to a natural-language text string generated by the processor, which describes desired content characteristics based on the information category, age group, and optionally user state information, and is supplied to a generative AI model as an input condition for generating a character information sequence.

The term “generative information processing model” refers to a software or hardware system that includes at least one generative AI model and that performs generation of content, such as text, based on an input prompt sentence.

The term “generative AI model” refers to a machine-learned model that probabilistically generates new data, such as text in the form of a character information sequence, in response to input conditions expressed by a prompt sentence.

The term “character information sequence” refers to a sequence of symbols representing textual content, such as characters, words, or tokens, produced by the generative AI model in response to the prompt sentence.

The term “post-processing” refers to one or more processing operations applied to the character information sequence after it is received from the generative AI model, including formatting, phrase filtering, segmentation, and combination, in order to convert the raw output into visual-presentation information suitable for display.

The term “formatting” refers to a post-processing operation that adjusts the layout, punctuation, spacing, or structural markup of the character information sequence, such as inserting line breaks, paragraph markers, or other formatting indicators.

The term “phrase filtering” refers to a post-processing operation that detects and replaces, masks, or removes particular words, phrases, or expressions in the character information sequence based on predetermined rules or lists.

The term “segmentation/combination” refers to a post-processing operation that divides a character information sequence into segments or merges multiple segments, such as splitting or joining sentences, paragraphs, or sections, to produce coherent and structured content.

The term “visual-presentation information” refers to content data, derived from the character information sequence, that has been processed and formatted in a manner appropriate for visual display on a display unit or a visual display apparatus.

The term “visual display apparatus” refers to an output device or combination of devices, including at least one of a portable information terminal and a wearable display device, that receives visual-presentation information and presents it visually to the user.

The term “portable information terminal” refers to a hand-held or mobile computing device, such as a smartphone or tablet, that can perform communication, processing, and display functions while being carried by the user.

The term “wearable display device” refers to an apparatus worn on the user's body, such as head-mounted glasses, a head-mounted display, or another body-mounted visualization device, that presents visual-presentation information within the user's field of view.

The term “streaming scheme” refers to a transmission mode in which portions of the visual-presentation information or character information sequence are sent and rendered incrementally over time, enabling progressive display before the entire content is generated or transmitted.

The term “batch scheme” refers to a transmission mode in which the visual-presentation information or character information sequence is transmitted and displayed substantially as a complete unit rather than in incremental portions.

The term “regeneration instruction” refers to an input from the user, received via the visual display apparatus or information processing terminal, that requests generation of new content under the same or similar conditions, thereby triggering a re-execution of prompt sentence generation and content generation.

The term “condition-change instruction” refers to an input from the user, received via the visual display apparatus or information processing terminal, that requests modification of generation conditions, such as information category or age group, and causes the processor to generate a new prompt sentence and obtain new content.

The term “state information of the user” refers to information indicative of a physical or psychological state of the user, including but not limited to emotional state, engagement level, or attention state, which may be inferred from signals such as sensor data, behavioral data, or interaction patterns.

The term “emotion estimation processing unit” refers to a hardware or software component that receives input related to the user, such as sensor outputs or interaction logs, and estimates the user's state information, including emotional state, for use in adjusting the character information sequence or visual-presentation information.

The term “constituent elements of the character information sequence” refers to structural or semantic units within the generated content, including appearing entities, scene settings, story developments, themes, and other narrative or descriptive components.

The term “appearing entities” refers to characters, objects, creatures, or other identified elements that appear as actors or participants within the generated content.

The term “scene settings” refers to environmental or situational descriptions in the generated content, including locations, time settings, and contextual backgrounds in which the appearing entities act.

The term “story developments” refers to narrative progressions or plot elements in the generated content, including events, conflicts, resolutions, and transitions between scenes.

The term “image medium” refers to a visual content form, such as an illustrated material, digital picture set, or graphical layout, that can be associated with or derived from the generated character information sequence.

The term “theme of an image medium” refers to a conceptual or narrative focus for the image medium, such as a subject, motif, or storyline, that is selected in association with the information category, the age group, and the user's state information.

The term “group of appearing entities” refers to a set of appearing entities selected as candidates to be included or emphasized in the generated content and corresponding visual elements.

The term “group of visual elements” refers to a set of graphical or layout components, such as character illustrations, background images, color schemes, or iconography, which can be used to visually represent the theme and the appearing entities associated with the generated content.

In one embodiment, a server cooperates with terminals operated by users to implement a system that generates and adaptively presents content based on a generative AI model. The server includes at least one processor, a main memory, a nonvolatile storage device, and a network interface. The server connects to one or more terminals via a packet-based communication network such as the Internet. Each terminal includes a display unit, an operation unit, a local processor, a memory, and optionally one or more sensors such as a camera or a microphone. The terminals include, for example, smartphones, tablet devices, and head-mounted display devices.

The server executes application software implemented, for example, using a general-purpose programming language such as Python running on an operating system such as a UNIX-compatible server operating system. The server provides a remote application programming interface (API), for example using a framework such as a Python-based web framework that exposes endpoints over HTTPS. The terminals execute client-side applications implemented, for example, as native mobile applications for smartphones or web applications rendered in a browser engine. The terminals communicate with the server via secure communication using a transport layer security protocol.

The server manages a data structure that represents user selection information in a structured format. The server uses, for example, a key-value object in which an “information category” and an “age group” are stored as respective fields. The server stores this structured data in main memory and in a database system such as a relational database or a document-based storage engine for logging, analysis, and reuse.

The server generates a natural-language prompt sentence from the structured selection information. The server maps internal identifiers of information categories and age groups to template phrases stored in a prompt template repository. The server uses a set of transformation rules that convert discrete category codes and age range values into human-readable expressions. For example, the server converts an internal category code “ADV” to the phrase “an adventure story” and an age value of 5 to the phrase “a 5-year-old child.” The server then combines these phrases using predetermined syntactic patterns to generate a complete prompt sentence. Examples of such prompt sentences include:
“Please generate an adventure story suitable for a 5-year-old child. The story should be simple, friendly, and use short sentences. The main character should be a brave child who explores a magical forest with an animal friend. The story length should be about 500 words.”
“Please generate a science-fiction story suitable for a 10-year-old child. The story should be exciting but not too scary. The main character should travel in a spaceship and learn one easy-to-understand scientific idea about space. The story length should be about 800 words.”

The server thereby performs a non-trivial data transformation from a compact, structured representation to a semantically rich, natural-language prompt sentence. By using template structures and mapping rules stored in a machine-readable format, the server reduces prompt variability and improves consistency across different requests, yielding more predictable behavior of the generative AI model.

The server provides the generated prompt sentence as input to a generative information processing model. The generative information processing model includes a generative AI model implemented as a multi-layer neural network, such as a transformer-based language model. The generative AI model is trained on a large corpus of text using a self-supervised learning algorithm. During training, the generative AI model minimizes a loss function such as a cross-entropy loss over predicted token distributions relative to ground-truth tokens. The generative AI model updates internal weight parameters using an optimization algorithm such as stochastic gradient descent or a variant thereof, for example with adaptive learning rate control. The neural network includes multiple attention layers, feed-forward layers, normalization layers, and embedding layers. The model accepts tokenized input sequences, applies positional encodings, and computes context-dependent representations through attention mechanisms across multiple layers. The model outputs probability distributions for subsequent tokens, from which tokens are sampled or selected according to a decoding strategy such as greedy decoding, top-k sampling, or nucleus sampling.

The server interfaces with the generative AI model via a dedicated model-serving interface.

In one embodiment, the server communicates with a remote model service through a REST or RPC interface; in another embodiment, the server hosts the generative AI model locally, executing it on an accelerator device such as a graphics processing unit. In each case, the server transmits to the generative AI model a request that specifies the prompt sentence and one or more control parameters such as maximum output length, temperature, and sampling parameters. These parameters control the entropy of the output distribution and the length of the character information sequence. The generative AI model returns a character information sequence that encodes the generated story.

The server receives the output of the generative AI model in an incremental or batch fashion.

In a streaming configuration, the generative AI model emits tokens or text segments in small units. The server maintains an in-memory buffer that stores partial output, and the server appends each new segment to this buffer. The server performs post-processing on the buffer contents. For example, the server normalizes whitespace, inserts line breaks based on punctuation detection, consolidates repeated segments, and checks against a phrase filter table that lists expressions to be removed or replaced. The server also applies segmentation rules that split long sentences into shorter units appropriate for the selected age group, using heuristics or statistical thresholds on sentence length.

The terminal receives the visual-presentation information from the server. In a streaming configuration, the terminal receives partial sequences of text and updates the display incrementally. For example, the terminal inserts newly received text into a scrolling text area, displaying the story as it is generated. The terminals that are wearable display devices may render the story in a fixed position within the user's field of view, updating the content in real time while the user is wearing the device. The terminals adjust font size, line spacing, and color scheme based on the age group. For younger age groups, the terminal applies larger font sizes, increased line spacing, and high-contrast color schemes to improve legibility.

The user views the displayed content on the terminal and can provide feedback by operating the operation unit. For example, the user issues a regeneration instruction by pressing a “Generate another story” button. The terminal then sends a corresponding instruction to the server, which triggers regeneration using the same or modified selection parameters. The user can also provide a condition-change instruction by selecting a different information category or age group, upon which the server updates the structured data representation and constructs a new prompt sentence.

The server further includes an emotion estimation processing unit that obtains state information of the user. The terminals may supply sensor-derived data, for example facial image frames from a front-facing camera, acoustic signals from a microphone, movement data from an inertial measurement unit, or interaction event logs such as scroll speed and frequency of regeneration requests. The emotion estimation processing unit transforms these signals into feature vectors. In one embodiment, the emotion estimation processing unit uses a convolutional neural network to process facial images and a separate recurrent or transformer-based network to process temporal interaction patterns. The emotion estimation processing unit uses a classifier that outputs an estimated emotional label such as “bored,” “excited,” “confused,” or a continuous value representing engagement level.

The emotion estimation processing unit is trained on labeled datasets that associate sensor signals and interaction patterns with target emotional labels. The unit uses a loss function such as cross-entropy for classification or mean squared error for regression of engagement scores, and updates its weights via gradient-based optimization. The server stores the trained weights in a model parameter repository. At runtime, the emotion estimation processing unit executes inference on current user data, generating state information that represents the user's emotional condition. In some embodiments, the server fuses multiple modalities, such as facial features and interaction metrics, using a feature concatenation layer followed by fully connected layers that compute the final emotion estimate.

The server uses the state information to adjust the character information sequence. For example, when the emotion estimation processing unit indicates that the user is bored, the server selects rules that increase the frequency of surprising events or changes in scene settings in subsequent segments of the story. When the user is confused, the server reduces linguistic complexity by simplifying complex sentences, decreasing the number of new characters introduced, or adding clarifying phrases. The server implements these adjustments using a rule set and a transformation module. The transformation module identifies constituent elements such as appearing entities, scene settings, and story developments in the character information sequence, using natural-language analysis tools such as tokenization, part-of-speech tagging, and dependency parsing. The server then applies transformation rules that add, delete, or modify specific narrative elements according to the emotion estimation result. For example, the server may remove a subplot that requires high cognitive load for a young or confused user, or insert shorter explanatory sentences after technically complex descriptions for an older but less engaged user.

The server further uses the state information to influence the next prompt sentence and thereby steer subsequent output from the generative AI model. The server incorporates the emotion estimation result into the structured data representation and maps it to additional prompt constraints. For example, when the user is bored, the server generates a prompt sentence that includes phrases such as “make the story more exciting” or “introduce a surprising event in the middle of the story.” When the user appears anxious or fearful, the server adds constraints such as “avoid scary scenes and use gentle and reassuring language.”

This feedback loop between the emotion estimation processing unit and the prompt generation mechanism allows the server to reshape the behavior of the generative AI model in a targeted and technically controlled manner.

The server thereby performs non-conventional data processing beyond mere automation of human manual work. The server uses a specific combination of structured data representation for user selections, template-based natural-language prompt construction, transformer-based generative AI modeling, and emotion-conditioned content transformation. By using the structured data representation, the server can precompute and cache partial prompt components, reducing computation time for prompt generation and decreasing communication payload sizes when transmitting configuration parameters between modules.

By using the streaming scheme, the server reduces perceived latency and distributes processing load over time, which leads to a smoother utilization pattern on the model-serving infrastructure and the network.

The server improves computing efficiency by tailoring the generative AI model's output generation length and complexity based on the age group and emotional state information.

For example, the server instructs the model to generate shorter outputs with simpler vocabulary for younger or less engaged users, which reduces the number of tokens that must be computed by the neural network and transmitted over the network. This reduces computation time and communication bandwidth usage. The server also employs a phrase filtering step that removes unnecessary or repetitive content before transmission, further reducing payload size and rendering cost on the terminal.

The terminals benefit from this design by receiving already formatted and filtered visual-presentation information instead of raw model outputs. This reduces client-side processing complexity and enables terminals with limited computational resources, such as lightweight wearable devices, to render the content with lower power consumption. The server thus centralizes complex language and emotion processing, while the terminals focus on interaction and display.

The described system improves the functioning of the underlying computer network and the model-serving infrastructure. The combination of structured prompt construction, emotion-conditioned regeneration, and streaming delivery results in more predictable and stable request patterns. The server can batch or schedule generative AI model calls according to expected output length and urgency, which can reduce peak loads and increase throughput.

Moreover, by dynamically adapting story complexity and length, the server reduces unnecessary computation for users who would not benefit from long or complex stories, thereby improving overall computational efficiency.

In various alternative embodiments, the server may use different architectures for the generative AI model and the emotion estimation processing unit. For example, the generative AI model may be a recurrent neural network with attention mechanisms instead of a transformer, or a hybrid model that combines a retrieval component with a generative component. The emotion estimation processing unit may incorporate a support vector machine or gradient boosting model as a classifier in place of or in addition to a neural network. The server may also use different structured data formats, such as binary encoding schemes or protocol buffers, to represent user selections and state information. In some embodiments, the server may generate additional types of content such as summaries, quizzes, or explanations derived from the primary story, using the same framework of prompt sentence generation and generative AI invocation.

In another embodiment, the server may control not only textual content but also visual elements of an image medium. The server selects themes, groups of appearing entities, and groups of visual elements based on the information category, age group, and emotion estimation result. The server encodes these selections into prompt sentences for a generative AI model configured to generate descriptive text that can be used to drive a separate image synthesis engine. The server then coordinates the generation of both text and images, delivering them in a synchronized manner to the terminals. This integrated operation further leverages the structured data, prompt construction, and emotion-conditioned adaptation mechanisms, providing consistent technical advantages in terms of bandwidth utilization, model control, and user-specific tailoring.

The system thus provides a concrete implementation that improves computer technology by integrating structured data processing, advanced neural network architectures, and dynamic feedback control based on estimated user state. The server and terminals cooperate to achieve lower latency, reduced computation load, improved alignment between generated content and user characteristics, and enhanced stability of network and model-serving resources, thereby realizing technical effects that go beyond abstract content generation or mere automation of human storytelling tasks.

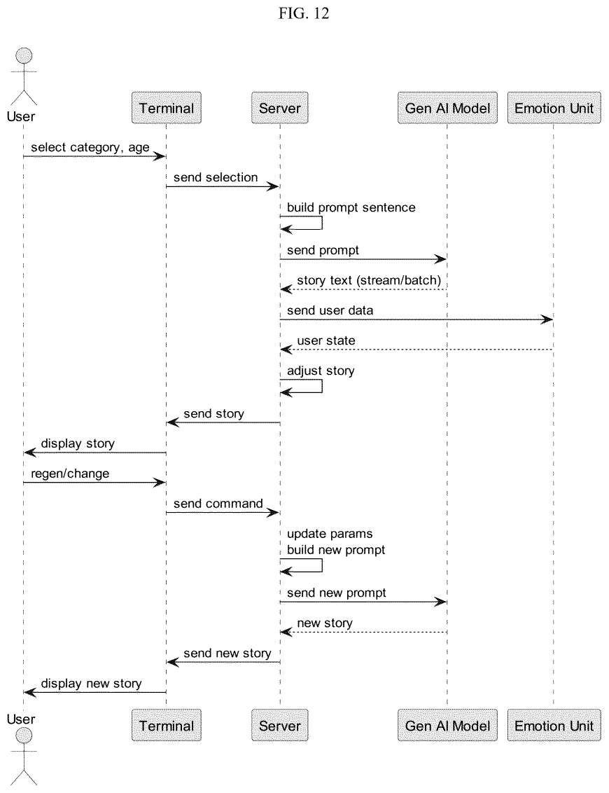

The following describes the processing flow using FIG. 12.

### Step 1:

The user operates the terminal to start the content application.
The terminal displays a user interface that includes controls for selecting an information category and an age group.
Input: no structured data yet; the terminal only has UI configuration data.
The user touches or clicks UI components, such as dropdown lists or buttons, to choose an information category (for example, “adventure”) and an age group (for example, “5”).
The terminal validates the selections locally by checking that the age value is within an allowed range and that the category is in a predefined list.
Output: the terminal holds validated selection values in memory as internal variables representing the chosen information category and age group.

### Step 2:

The terminal converts the internal selection variables into a structured data object.
Input: the selected information category and age group as local variables.
The terminal creates a key-value structure (for example, an object with fields “category” and “age”) and assigns the selected values to these fields.
The terminal serializes this structure into a machine-readable format suitable for transmission, such as a text-based object representation.
Output: the terminal produces a structured selection message that encodes the information category and age group.

### Step 3:

The terminal sends the structured selection message to the server over a communication network.
Input: the structured selection message held by the terminal.
The terminal opens a secure connection using a communication protocol and prepares a request to the server's API endpoint responsible for content generation.
The terminal embeds the structured selection message in the request body and transmits it through the network interface.
Output: the server receives a request that contains the user's selected information category and age group in structured form.

### Step 4:

The server parses and validates the received selection information.
Input: the structured request containing the information category and age group.
The server decodes the request body, reconstructs the key-value structure, and extracts the category and age values into local variables.
The server checks that the age value is within a permitted interval and that the category corresponds to a supported content type; if any check fails, the server constructs and returns an error response.
If validation succeeds, the server logs the selection and stores the structured data in memory or a database for downstream processing.
Output: the server holds validated selection parameters and a structured representation ready for prompt generation.

### Step 5:

The server generates a natural-language prompt sentence based on the structured selection information.
Input: the validated information category and age group stored in server variables.
The server consults a prompt template repository that holds mapping rules from internal category identifiers and age values to natural-language phrases.
The server retrieves phrases corresponding to the selected category (for example, “an adventure story”) and age group (for example, “a 5-year-old child”) and inserts them into a template structure.
The server combines these elements to form a complete prompt sentence, such as:
“Please generate an adventure story suitable for a 5-year-old child. The story should be simple, friendly, and use short sentences. The main character should be a brave child who explores a magical forest with an animal friend. The story length should be about 500 words.”
The server may add further constraints depending on system configuration or user profile.
Output: the server produces a finalized prompt sentence as a natural-language string ready to be sent to the generative AI model.

### Step 6:

The server submits the prompt sentence to the generative AI model.
Input: the prompt sentence generated in Step 5 and model control parameters such as maximum output length and temperature.
The server constructs a model request object that includes the prompt sentence and numeric parameters controlling generation behavior.
The server sends this object to the generative information processing model, which hosts the generative AI model, either locally or on a remote model-serving infrastructure.
Output: the generative AI model receives the prompt sentence and associated parameters and starts internal neural network computation to generate a character information sequence.

### Step 7:

The generative AI model produces a character information sequence in response to the prompt sentence.
Input: the prompt sentence and control parameters supplied by the server.
The generative AI model tokenizes the prompt, embeds tokens into vector representations, and processes them through multiple neural network layers that include attention and feed-forward computations.
The generative AI model computes probability distributions over possible next tokens and selects or samples tokens according to the configured decoding strategy.
The generative AI model repeats these operations to construct a sequence of tokens representing the generated story.
Output: the generative AI model outputs the character information sequence either as a full block or as incremental chunks transmitted back to the server.

### Step 8:

The server receives and accumulates the character information sequence from the generative AI model.
Input: one or more message units containing portions of the generated character information sequence.
The server appends each received portion to a buffer in main memory, maintaining the sequence in the proper order.
The server monitors completion signals from the generative AI model to determine when the full sequence has been received or when the sequence has reached an intended length.
Output: the server holds a complete or partial character information sequence in a buffer ready for post-processing.

### Step 9:

The server performs post-processing on the character information sequence to create visual-presentation information.
Input: the buffered character information sequence and the previously stored selection parameters such as age group.
The server analyzes the text to identify sentence boundaries and paragraphs and inserts line breaks and formatting markers accordingly.
The server compares words and phrases in the sequence against a phrase filtering table and replaces or removes any expressions that do not meet system policies.
The server adjusts sentence length and structure based on the age group, splitting long sentences into shorter ones for younger users and simplifying overly complex clauses.
The server constructs a formatted text structure that includes title fields, paragraph boundaries, and metadata for display.
Output: the server produces visual-presentation information, including formatted story text and associated layout metadata.

### Step 10:

The server invokes the emotion estimation processing unit using user-related input signals, when such signals are available.
Input: user-related data such as recent interaction logs, sensor readings, or previously captured facial imagery, along with the current or upcoming visual-presentation information.
The server feeds feature data derived from these signals to the emotion estimation processing unit, which computes state information indicating the user's emotional condition.
The server receives an emotion label or continuous engagement score and associates it with the current session.
Output: the server holds state information of the user that will be used to adjust the character information sequence or influence subsequent prompt sentences.

### Step 11:

The server adjusts the character information sequence or visual-presentation information based on the estimated user state.
Input: the visual-presentation information and the user state information produced in Step 10.
The server identifies constituent elements in the story, such as appearing entities, scene settings, and key story developments, using text analysis modules.
If the user is detected as bored, the server adds or emphasizes surprising events or accelerates the pace of the narrative by modifying sentences or inserting new lines.
If the user is detected as confused or overwhelmed, the server deletes or simplifies complex descriptions, reduces the number of concurrent plot lines, and may add clarifying sentences.
The server applies these modifications by altering the text structure in memory and updating the visual-presentation information accordingly.
Output: the server produces adjusted visual-presentation information that better matches the user's emotional state.

### Step 12:

The server transmits the visual-presentation information to the terminal for display.
Input: the finalized visual-presentation information, including any emotion-based adjustments.
The server selects a transmission mode: a streaming mode where segments of the story are sent progressively, or a batch mode where the entire story is sent at once.
The server packages the information into response messages and sends them over the network through the server's network interface.
Output: the terminal receives one or more messages containing visual-presentation information ready to be rendered on the display unit.

### Step 13:

The terminal renders the visual-presentation information on the display unit.
Input: the received visual-presentation information from the server.
The terminal parses the structure, extracts the title and body text, and maps formatting markers to visual styles such as font size, line spacing, and color.
The terminal draws the story text in a text area or multiple pages, and for streaming mode, updates the display incrementally as new segments arrive.
The terminal adapts presentation parameters (for example, larger fonts for younger age groups) based on metadata included in the visual-presentation information.
Output: the user sees the story on the display unit as readable, formatted content.

### Step 14:

The user consumes the content and optionally issues control instructions through the terminal.
Input: the displayed story and any visible control elements such as “Regenerate,” “Change category,” or “Change age group” buttons.
The user reads or views the story and, based on satisfaction or interest level, may press a regeneration button to obtain a new story with similar conditions, or may change the information category or age group.
Output: the terminal receives user control input representing either a regeneration instruction or a condition-change instruction.

### Step 15:

The terminal sends regeneration or condition-change instructions to the server.
Input: user control input indicating regeneration or change of conditions, as captured by the operation unit.
The terminal encodes the type of instruction and any updated selection parameters into a structured instruction message.
The terminal transmits this message to the server over the existing communication channel or by opening a new request.
Output: the server receives an instruction that either triggers prompt regeneration with the same conditions or updates the structured selection information with new parameters.

### Step 16:

The server updates internal state and repeats generation with modified conditions when appropriate.
Input: the instruction from the terminal and, when applicable, updated information category, age group, or inferred user state.
The server updates the structured selection data to reflect the new parameters or retains the existing data when only regeneration is requested.
The server generates a new prompt sentence that may incorporate the latest user state information, for example by adding constraints such as “make the story more exciting” or “use gentle and reassuring language,” and then resubmits this prompt to the generative AI model as described in earlier steps.
Output: the server initiates a new cycle of content generation and adjustment, providing updated character information sequences and visual-presentation information that reflect the user's latest selections and emotional state.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2.

The units of the system described below are implemented by the data processing device 12 and the smart device 14. The data processing device 12 is called a “server” and the smart device 14 is called a “terminal”.

Conventional content generation systems that employ a generative AI model typically operate in a one-shot manner: a user provides simple parameters such as a genre or a target age, a prompt sentence is composed in an ad hoc fashion, and the model returns static text. Such systems do not sufficiently exploit computer resources to dynamically adapt the generated content to the comprehension level and emotional state of an individual user during an interactive reading session. As a result, these systems often output text that is linguistically inappropriate for the target age, either too complex or too simplistic, and that fails to respond to a user's emotional reactions in real time.

Moreover, in known systems, the process of converting raw generated text into a structured multi-page format suitable for picture-book presentation is typically performed manually or with minimal, fixed templating. This requires additional human intervention, increases processing latency, and prevents the system from providing consistently formatted, machine-processable page structures. The absence of automated page division, age-adjusted vocabulary control, and systematic generation of image description text for each page leads to inefficient utilization of processing resources and hinders reliable integration with downstream components such as rendering engines or auxiliary generative models.

Further, most existing systems treat emotional analysis, if present, as a separate, post-hoc layer that does not feed back into the generative process or the structural representation of the content. Emotional assessment is not tightly coupled to the prompt design, the generative AI model invocation, or the restructuring of generated text on a sentence and page level. As a consequence, conventional architectures cannot dynamically reconstruct story elements such as appearing entities, scene configuration, and ending expressions in response to changing user emotions while preserving a coherent, machine-readable page structure.

Accordingly, there is a need for an improved computer-implemented system that: (i) programmatically generates prompt sentences based on user-specified content type and target age; (ii) automatically calls a generative AI model and post-processes the returned text using age-dependent linguistic constraints; (iii) converts such processed text into structured page-level data with associated image description text; and (iv) integrates emotion estimation processing into this pipeline so that vocabulary, sentence structure, page composition, and story elements can be dynamically adjusted in a repeatable and scalable manner. Such a system should improve the operation of the computer itself in managing interactive story generation by reducing manual intervention, enforcing consistent data structures, and enabling adaptive content generation responsive to user emotions.

The specific processing by the specific processing unit 290 of the data processing device 12 in Example 2 is realized by the following means.

The present invention provides a server comprising a processor configured to generate, on a user output device, an input/output screen through which a user is enabled to specify a type of content and a target age of a recipient, and to acquire the specified type of content and the specified target age via the input/output screen; to automatically generate a prompt sentence for instructing a generative AI model to generate text, by embedding the acquired type of content and the acquired target age into a predefined character-string template by character-string processing; to transmit the generated prompt sentence as a communication request to an external generative AI model providing apparatus, and to receive text data output from the generative AI model in response to the prompt sentence; to process the received text data in accordance with reference information relating to vocabulary difficulty and sentence length corresponding to the target age, by dividing the text data into units of sentences or paragraphs, replacing words having a high difficulty level with words having a lower difficulty level, and splitting sentences exceeding a predetermined number of characters or a predetermined number of sentences; to divide the processed text data into a plurality of pages, to automatically generate, for each page, an image description text for instructing a visual expression corresponding to the type of content and the target age, and to generate page-structure data including, for each page, page text data and the image description text; to transmit the page-structure data to the user output device and to cause the user output device to output the page-structure data in a display format in which page turning is possible; to acquire, from the user output device, user correction input with respect to the page-structure data, and to store, in a storage device, page-structure data in which the user correction input is reflected; and to execute emotion estimation processing to estimate an emotional state of the user with respect to the generated text data, and, based on the estimated emotional state, to adjust the page-structure data by changing at least a part of vocabulary, sentence structure, page composition, an appearing entity, a scene configuration, an ending expression, or a subject of the content as a whole. This enables the computer system to automatically and iteratively generate, structurally organize, and dynamically adapt multi-page content in response to age-dependent linguistic constraints and user emotions, thereby improving the technical functioning of the content generation pipeline and reducing the need for manual intervention in prompt design, text post-processing, and story restructuring.

The term “user output device” refers to an information processing apparatus, such as a terminal or display device, that presents screens to a user, accepts user input through an input/output interface, and communicates such input to a server.

The term “input/output screen” refers to a graphical or textual user interface presented on a user output device, through which a user is enabled to view information and input parameters, such as a type of content and a target age.

The term “type of content” refers to a classification or category of content to be generated, such as a genre, style, or format, which is used as a parameter for controlling text generation by a generative AI model.

The term “target age” refers to an age or age range of an intended recipient or reader of the generated content, which is used to control linguistic complexity, story structure, and other content characteristics.

The term “prompt sentence” refers to a text string including instructions, conditions, and constraints provided to a generative AI model, which is used by the model as an input for generating text data.

The term “generative AI model” refers to a machine-implemented model, such as a statistical or neural network model, that generates text or other data in response to input instructions, including prompt sentences.

The term “character-string template” refers to a predefined text pattern including fixed portions and variable portions, into which parameters such as the type of content and the target age are embedded to form a complete prompt sentence.

The term “character-string processing” refers to operations performed by a processor on text data, including concatenation, replacement, insertion, and formatting, for generating or modifying character strings.

The term “external generative AI model providing apparatus” refers to a computing system or service, separate from the server executing the claimed processor, that executes a generative AI model and returns generated data in response to requests.

The term “text data” refers to machine-processable data representing natural-language text, such as sentences and paragraphs, that is output by a generative AI model.

The term “reference information relating to vocabulary difficulty and sentence length” refers to stored data defining criteria or thresholds for word complexity and sentence size, which are used by the processor to adjust and evaluate text in accordance with the target age.

The term “processed text data” refers to text data that has been modified by the processor according to predetermined rules, including division into units, vocabulary replacement, and sentence splitting.

The term “page-structure data” refers to structured data representing a multi-page configuration of content, including, for each page, text data, associated image description text, and optionally page identifiers and ordering information.

The term “image description text” refers to a textual description associated with a page, specifying visual elements, styles, or scenes to be used for generating or selecting images or other visual expressions corresponding to the page.

The term “display format in which page turning is possible” refers to a presentation mode in which a user output device displays pages of content and allows a user to navigate among the pages by operations such as swiping, clicking, or tapping.

The term “user correction input” refers to input data received from a user that modifies, replaces, or augments text or other elements within page-structure data.

The term “storage device” refers to a hardware component or system, such as a memory or persistent storage unit, that stores data including page-structure data in which user correction input is reflected.

The term “emotion estimation processing” refers to a computational procedure executed by a processor to infer or classify a user's emotional state on the basis of input such as biometric information, operation-history information, or uttered-voice information.

The term “emotional state” refers to a condition or category of user emotion, such as happiness, sadness, fear, or excitement, identified or inferred by emotion estimation processing.

The term “appearing entity” refers to an actor, character, or object that appears as a participant or subject within the generated content or story.

The term “scene configuration” refers to an arrangement of contextual elements, such as background settings, events, and interactions, that together define a particular situation or scene within the generated content.

The term “ending expression” refers to a textual portion representing the conclusion or resolution of the generated content or story, including final events and outcome descriptions.

The term “subject of the content as a whole” refers to an overarching theme, topic, or main idea that characterizes the generated content or story in its entirety.

In one embodiment, a server, a terminal, and a network together implement the claimed system. The server includes at least one processor, a memory, and a storage device.

The processor can be implemented, for example, on a general-purpose computing platform such as an x86-based rack server or a virtual machine instance in a cloud computing environment. The memory stores program modules that cause the processor to execute the functions described below. The storage device, such as a magnetic disk, solid-state drive, or network-attached storage, stores configuration data, reference information, trained model parameters, and generated page-structure data.

The terminal includes at least one processor, a display device, and an input device. The terminal can be realized as a smartphone, a tablet computer, or a personal computer executing a browser application or a dedicated client application. The terminal communicates with the server via a communication network, such as the Internet, using a transport protocol such as HTTPS.

The terminal presents to the user a graphical user interface that constitutes an input/output screen. The terminal uses a rendering engine, for example a browser engine, to display input fields, selection controls, and buttons that allow the user to specify a type of content and a target age. The terminal acquires user input by detecting touch operations, mouse operations, or keyboard operations on the displayed interface. The terminal then encapsulates the type of content and the target age in a structured request message, such as a JSON object, and transmits the request to the server.

The server receives the request and stores the type of content and the target age in a structured in-memory representation, such as a key-value map or an object. The server next executes a prompt-generation module that resides in the memory. This module uses a character-string template stored in the storage device and performs character-string processing to embed the type of content and the target age in predetermined placeholder positions in the template. Because the server employs explicit templates, the server can enforce a uniform syntactic and semantic structure for every prompt sentence, thereby improving stability in the behavior of the generative AI model.

In one example, the server generates a Japanese-language prompt sentence such as:
“Please generate a picture-book story in the adventure genre for a 3-year-old child. Keep the sentences short and simple, and use words that a 3-year-old child can understand. Structure the story into 8 pages, and write 2 to 3 sentences on each page.”

In another example, the server generates an English prompt sentence such as:
“Please create a short picture-book story in the adventure genre for a 3-year-old child. Use very simple English, write 2-3 short sentences per page, and structure the story into 8 pages. Make the tone bright and friendly, and avoid any scary or violent scenes.”

The server transmits the prompt sentence to an external generative AI model providing apparatus. In one embodiment, the generative AI model is implemented as a large-scale neural network having a transformer architecture. The generative AI model includes a plurality of self-attention layers, feed-forward layers, and embedding layers. The generative AI model has been trained in advance using a training dataset containing sequences of tokens.

During training, the generative AI model minimizes a loss function, such as cross-entropy between predicted token distributions and target tokens, by updating weight parameters using an optimization algorithm, such as stochastic gradient descent with adaptive learning rate.

The generative AI model uses positional encodings to represent token order and uses multi-head attention mechanisms to compute context-dependent representations of tokens.

During inference, the server transmits the prompt sentence as a sequence of tokens to the external apparatus. The generative AI model converts the tokens into numerical embeddings, propagates the embeddings through the attention layers and the feed-forward layers, and computes probability distributions over a vocabulary for each next token. The generative AI model selects output tokens based on these probability distributions, for example using sampling or beam search, and outputs generated text data. The external apparatus then returns the generated text data to the server via the network.

The server receives the text data and stores it in the memory as raw text. Thereafter, the server executes a linguistic-adjustment module. This module accesses reference information relating to vocabulary difficulty and sentence length from the storage device. The reference information includes, for example, a mapping between words and difficulty levels, statistics on recommended maximum characters per sentence for each target age, and lists of permitted and prohibited expressions for each age group. The server divides the text data into sentences or paragraphs by applying rule-based tokenization, which uses punctuation marks and language-specific rules, and optionally by using a statistical or neural sentence boundary detector.

The server compares individual words in each sentence with the reference information. When the server determines that a word has a difficulty level exceeding a threshold for the target age, the server replaces the word with a simpler synonym obtained from a synonym table or from a precomputed mapping that associates difficult words with age-appropriate equivalents. The server also measures sentence length in terms of characters or tokens and splits sentences exceeding a threshold length into two or more sentences, inserting appropriate conjunctions or punctuation. Because these operations are executed automatically by the server based on quantitative criteria, the server can consistently conform the generated text to age-dependent linguistic constraints without increasing processing burden on the user.

After linguistic adjustment, the server executes a page-structuring module. The server divides the processed text data into a plurality of pages. The server uses rules stored in the storage device, which define, for example, a maximum number of sentences per page for a given target age. For a young age, such as three years old, the server may place two to three short sentences on each page, whereas for an older age, the server may place more sentences on each page. The server assigns a page identifier to each page and stores page-level text segments in a page-structure data object.

The server also generates image description text for each page. The server can apply a deterministic mapping rule based on the type of content, target age, and page-level text segment, such as extracting subject nouns and verbs from the text and adding attributes corresponding to brightness, colorfulness, or emotional tone. In one embodiment, the server uses a lightweight natural language analysis module that identifies named entities, actions, and locations in the page text and produces an image description such as “a bright, colorful forest with a small child hero” or “a friendly dragon smiling next to a small child.” The server stores, for each page, the page text data and the associated image description text in the page-structure data.

The server transmits the page-structure data to the terminal via the network. The terminal receives the page-structure data, parses the structure, and renders a page-turning display format. The terminal displays the text and image description text and may use the image description text as metadata to retrieve or generate actual images using a separate image-generation module. Because the server provides the page-structure data in a consistent structured format, downstream components, such as rendering engines and image generators, can operate efficiently without performing additional parsing or restructuring.

The terminal enables the user to perform corrections on the page-structure data. For example, the user can edit a word in a page text or modify an image description. The terminal detects such operations and transmits correction data to the server. The server merges the correction data into the stored page-structure data and updates the storage device accordingly. As a result, the server maintains a persistent, versioned representation of the story that includes both automatically generated and user-corrected content.

The server also executes emotion estimation processing. In one embodiment, the terminal acquires biometric information such as heart rate or facial expression data using sensors, operation-history information such as reading speed, page dwell time, or pattern of page turning, and uttered-voice information such as exclamations detected by a microphone. The terminal transmits these data streams to the server. The server stores the received data in a temporal sequence and, in one embodiment, applies a feature extraction module that computes numerical features, such as average heart rate, variation in reading speed, frequency of specific vocal expressions, or changes in facial expression over time.

The server then inputs these features into an emotion classifier model. The emotion classifier can be realized as a neural network, for example a feed-forward network or a recurrent network, that has been trained on labeled training data associating feature vectors with emotion labels such as “happy,” “bored,” or “anxious.” The classifier uses an error function, such as cross-entropy between predicted emotion probabilities and ground truth labels, and updates weights during training using a gradient-based optimization algorithm. In runtime, the classifier outputs probabilities for each emotion category. The server determines the emotional state as the category with the highest probability or as a mixture of categories that exceed threshold probabilities.

Based on the estimated emotional state, the server adjusts the page-structure data. For example, when the emotional state corresponds to boredom, the server may modify subsequent pages by increasing the pace of events, introducing an additional appearing entity, or changing the scene configuration to a more dynamic environment. When the emotional state corresponds to fear for content directed at young children, the server may reduce the intensity of conflict by altering an ending expression into a more reassuring outcome or by converting an antagonist into a friendly entity. The server applies rule-based transformations that map emotion categories and content type to predesigned story adjustment patterns. These transformations can involve substitution of phrases, reordering of sentences, insertion of clarifying sentences, or removal of scenes. Because these rules are implemented as algorithmic transformations on the page-structure data, the server can dynamically reconstruct story elements in a consistent and repeatable way that is not achievable by manual editing in real time.

In some embodiments, the server uses the emotion estimation result not only to post-process the generated text but also to refine subsequent prompt sentences supplied to the generative AI model. For example, when the server detects that the user is highly engaged and happy with a particular appearing entity, the server can generate a follow-up Japanese-language prompt sentence that instructs the generative AI model to extend the role of that entity, such as:
“Using the kind dragon that appeared on the previous page as the main character, please generate a bright and fun continuation of the story for a 3-year-old child, consisting of 3 pages”

By embedding emotion-dependent constraints into the prompt sentence, the server guides the generative AI model to produce content that aligns with the current emotional state while maintaining age-appropriate linguistic characteristics. Compared with conventional fixed prompts, this iterative, emotion-aware prompt composition reduces the need for trial-and-error prompt tuning and improves the consistency of generated content across multiple pages and sessions.

The above-described configuration provides several technical effects. Because the server uses pre-structured templates, age-dependent linguistic constraints, and programmatic page division, the server reduces variability in model output, thereby decreasing the amount of downstream corrective processing. The automated vocabulary replacement and sentence splitting using reference information enable the server to achieve a target readability level with lower computational overhead than approaches that rely on repeatedly invoking the generative AI model to re-generate entire passages. The structured page-structure data, which explicitly associates page text and image description text, improves data management by allowing the server to perform page-wise updates, caching, and synchronization, thereby reducing communication load between the server and the terminal when only part of the story is modified.

The emotion estimation processing, implemented as a trained classifier operating on multi-modal features, allows the server to adapt story content using rules that differ from typical human editing processes. Rather than simply simulating a human editor, the server applies formalized mappings from emotion categories to transformation templates. This enables the server to perform rapid, large-scale, and fine-grained restructuring of story elements across multiple pages. Because these transformations are applied on structured data, the server can guarantee that the story remains coherent and that page identifiers, image description associations, and age-dependent constraints remain satisfied, thus reducing errors in the interactive reading experience.

In alternative embodiments, the server can use different types of generative AI models, such as smaller transformer models running locally, encoder-decoder models, or recurrent models.

The server can also support multiple languages by storing separate character-string templates and reference information for each language. The emotion classifier can be replaced or supplemented by rule-based detectors that infer user emotion from specific measurable behaviors, such as repeated page rereads or abrupt session terminations. The page-structuring module can be configured with different page division policies, such as semantic segmentation based on topic shifts instead of fixed sentence counts.

In another variation, the server can use the image description text as input to an image generation model implemented as a generative adversarial network or a diffusion model. The image generation model can receive the image description text as a conditioning signal and generate image data corresponding to each page. By associating image description text with page identifiers, the server can delay image generation until the terminal actually requests a particular page, thereby reducing computation and bandwidth usage.

Because the server coordinates prompt generation, generative AI model invocation, age-aware text processing, structured page data management, and emotion-driven story adjustment in an integrated data flow, the system improves the functioning of the underlying computer technology. The server reduces the number of model calls and network round trips required to obtain acceptable content, shortens response time, limits redundant data transmission by operating on structured page units, and maintains consistency of multi-page content under continuous adaptation. These improvements go beyond simple automation of human editorial work and provide a specific, technical enhancement to the way computing systems generate, store, and adapt narrative content using generative AI models and structured page-level representations.

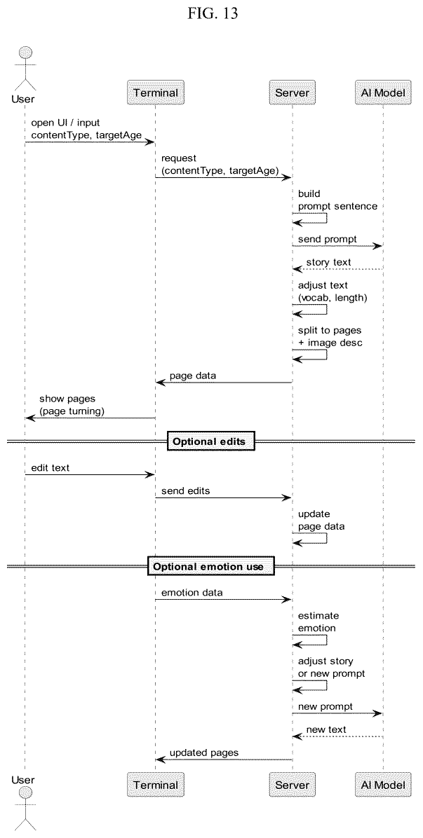

The following describes the processing flow using FIG. 13.

### Step 1:

The user operates the terminal to open a content-generation screen.
The terminal displays an input/output screen that includes input fields for a type of content and a target age, together with a “Generate Story” activation control.
Input: The terminal receives user input specifying the type of content (for example, “adventure”) and the target age (for example, “3”).
Processing: The terminal validates the input (for example, checks that the age is numeric and within an allowed range, and that the type of content is in a supported list) and converts the validated values into an internal data structure, such as a key-value map.
Output: The terminal holds a structured parameter set {type_of_content, target_age} ready to be transmitted to the server.

### Step 2:

The terminal constructs a request message to the server.
Input: The terminal uses the structured parameter set {type_of_content, target_age} generated in Step 1.
Processing: The terminal serializes the parameters into a request payload (for example, a JSON string) and attaches metadata such as a session identifier and language code. The terminal then encapsulates this payload in an HTTP request directed to a predefined API endpoint on the server.
Output: The terminal transmits the HTTP request over a network, and the server receives a request containing the type of content and the target age.

### Step 3:

The server parses and validates the received request.
Input: The server receives the HTTP request containing a serialized payload with the type of content and the target age.
Processing: The server invokes a request-handling module to parse the payload, reconstructs the internal representation (for example, a dictionary), and performs validation checks, such as verifying that fields are present, within acceptable ranges, and conform to configuration rules stored in memory. If validation fails, the server constructs an error response; if validation succeeds, the server proceeds to prompt generation.
Output: The server produces a validated parameter set {type_of_content, target_age} for use by downstream modules.

### Step 4:

The server generates a prompt sentence for a generative AI model.
Input: The server uses the validated parameter set {type_of_content, target_age} and a character-string template retrieved from storage.
Processing: The server performs character-string processing that inserts the type of content and the target age into placeholder positions in the template. The server may append fixed instructions regarding page count, sentence length, tone, and safety constraints. The server concatenates these components to form a single prompt sentence. For example, the server generates:
“Please generate a picture-book story in the adventure genre for a 3-year-old child. Keep the sentences short and simple, and use words that a 3-year-old child can understand. Structure the story into 8 pages, and write 2 to 3 sentences of story text on each page.”
Output: The server outputs a completed prompt sentence ready to be submitted to the generative AI model.

### Step 5:

The server submits the prompt sentence to an external generative AI model and obtains generated text data.
Input: The server uses the completed prompt sentence from Step 4.
Processing: The server encapsulates the prompt sentence in a model-request data structure (for example, specifying model name, maximum token count, and randomness parameters) and sends it via network communication to an external apparatus hosting the generative AI model. The external apparatus tokenizes the prompt sentence, performs numerical embedding and neural-network inference, and returns generated text data as a response. The server receives the response, extracts the generated text string from the response fields, and stores it in memory as raw text.
Output: The server produces raw generated text data representing a story corresponding to the prompt sentence.

### Step 6:

The server normalizes and segments the generated text data into units suitable for further processing.
Input: The server uses the raw generated text data from Step 5.
Processing: The server applies text normalization operations, such as trimming whitespace, converting full-width characters to half-width if needed, and standardizing punctuation. The server then performs sentence or paragraph segmentation, using punctuation marks and language-specific rules or a preconfigured sentence-boundary detection algorithm, to divide the text into discrete units.
Output: The server produces an ordered list of text units (for example, sentences) that represent the story in a structured form.

### Step 7:

The server adjusts vocabulary difficulty based on the target age.
Input: The server uses the ordered list of text units from Step 6, the target age from Step 3, and reference information relating to vocabulary difficulty retrieved from storage.
Processing: The server iterates over each text unit, tokenizes it into words, and consults a difficulty table that maps words to difficulty levels and age thresholds. When the server detects a word whose difficulty level exceeds the threshold for the target age, the server replaces that word with a simpler synonym obtained from a synonym mapping table or rules.
The server recombines the modified words into adjusted text units.
Output: The server generates an updated list of text units in which vocabulary is adapted to the target age.

### Step 8:

The server controls sentence length in accordance with age-dependent constraints.
Input: The server uses the updated list of text units from Step 7, the target age from Step 3, and reference information specifying maximum sentence length.
Processing: The server measures sentence length in characters or tokens for each text unit and compares the length to a threshold derived from age-specific configuration. When a sentence exceeds the threshold, the server identifies suitable split points, such as conjunctions or punctuation, and divides the sentence into two or more shorter sentences, optionally inserting connecting words to maintain coherence.
Output: The server outputs a refined list of text units (sentences) that satisfy both vocabulary and length constraints for the target age.

### Step 9:

The server groups text units into page-level segments.
Input: The server uses the refined list of text units from Step 8 and page-division rules for the target age retrieved from storage.
Processing: The server applies a page-grouping algorithm that assigns a fixed or bounded number of sentences to each page, based on age-dependent configuration (for example, two or three sentences per page for a low target age). The server sequentially accumulates sentences into page groups until the threshold per page is reached, then starts a new page group.
Output: The server generates a sequence of page segments, each page segment containing a subset of the story's sentences.

### Step 10:

The server generates image description text for each page.
Input: The server uses the sequence of page segments from Step 9 and, optionally, the type of content and target age from Step 3.
Processing: The server analyzes each page segment using a lightweight natural-language analysis module to identify key entities, actions, and settings. The server then formats an image description text containing these elements and additional attributes such as color tone and emotional nuance suitable for the target age. For example, for a page describing a child meeting a dragon, the server may generate an image description such as “a bright, colorful dragon smiling kindly at a small child in a sunny field.”
Output: The server produces, for each page segment, a pair {page_text, image_description}.

### Step 11:

The server constructs page-structure data and stores it.
Input: The server uses all pairs {page_text, image_description} from Step 10 and meta-information such as the type of content and target age.
Processing: The server assigns page identifiers, orders the pages, and organizes the pairs into a structured page-level data object. The server attaches metadata, such as story identifier, language, and generation timestamp. The server writes this page-structure data into memory and, optionally, into persistent storage so that it can be retrieved for later display or editing.
Output: The server creates and stores a complete page-structure data object representing the multi-page story.

### Step 12:

The server transmits the page-structure data to the terminal.
Input: The server uses the page-structure data object from Step 11.
Processing: The server serializes the page-structure data into a response payload, for example a structured text format, and encapsulates it in an HTTP response directed to the terminal.
Output: The server sends the response, and the terminal receives the page-structure data that includes page text and image description text for each page.

### Step 13:

The terminal renders the story in a page-turning display format.
Input: The terminal uses the page-structure data received from the server in Step 12.
Processing: The terminal parses the structure, extracts page text and associated image description text, and constructs a user interface in which each page is rendered with readable text and, if available, corresponding graphics generated or selected based on the image description text. The terminal configures navigation controls to allow the user to move between pages by swiping, tapping, or clicking.
Output: The terminal displays the first page of the story and prepares additional pages for interactive page-turning.

### Step 14:

The user interacts with the displayed pages and optionally edits content.
Input: The user views the page-turning interface rendered by the terminal and may choose to edit text or image descriptions.
Processing: The user performs operations such as tapping an “Edit” control, selecting a sentence, and entering replacement text via a keyboard or on-screen input. The terminal captures these modifications, associates them with specific page identifiers and text positions, and constructs correction data describing the changes.
Output: The terminal maintains a set of user corrections linked to the original page-structure data.

### Step 15:

The terminal transmits user correction input to the server.
Input: The terminal uses the set of user corrections generated in Step 14.
Processing: The terminal serializes the corrections into a structured payload that includes story identifier, page identifiers, and specific changes, and sends this payload to the server via an HTTP request.
Output: The server receives a correction request containing detailed user correction input.

### Step 16:

The server merges user corrections into the stored page-structure data.
Input: The server uses the correction request from Step 15 and the existing page-structure data from Step 11.
Processing: The server locates the corresponding story record and page entries, applies the corrections by replacing or updating text fields and image description fields, and preserves a coherent structure by maintaining page ordering and identifiers. The server updates the stored page-structure data in persistent storage, optionally recording version information.
Output: The server produces an updated page-structure data object that reflects user edits.

### Step 17:

The terminal and server cooperate to collect emotion-related data during reading.
Input: The terminal uses ongoing user interaction with the displayed pages and, where available, sensor data from devices such as cameras, microphones, or biometric sensors.
Processing: The terminal extracts raw signals, such as facial images, voice snippets, or interaction logs (for example, dwell time per page, rapid backtracking), and packages them as emotion-related data. The terminal sends this data to the server in periodic or event-driven messages.
Output: The server receives time-stamped emotion-related data associated with the reading session.

### Step 18:

The server estimates the emotional state of the user.
Input: The server uses the emotion-related data from Step 17 and a trained emotion classifier model stored in memory.
Processing: The server preprocesses the input by extracting numerical features (for example, average page dwell time, variance in reading speed, frequency of specific voice exclamations, detected facial expression scores). The server inputs the resulting feature vectors into the emotion classifier, which outputs probabilities for a set of emotion categories. The server selects one or more dominant emotions based on probability thresholds and designates these as the current emotional state.
Output: The server produces an emotion label or distribution representing the user's emotional state during reading.

### Step 19:

The server adjusts subsequent story content based on the estimated emotional state.
Input: The server uses the current emotional state from Step 18, the page-structure data from Step 11 or Step 16, and optional rules mapping emotions to story transformations.
Processing: The server selects transformation rules appropriate for the emotion and applies them to planned or yet-to-be-displayed pages. For example, the server may modify vocabulary to be more reassuring, adjust sentence ordering to smooth pacing, insert or remove appearing entities, or alter an ending expression to reduce perceived threat. These operations are performed on the structured representation, ensuring coherence and maintenance of age-dependent constraints.
Output: The server generates a revised set of page segments for future pages, forming updated page-structure data tailored to the user's emotional state.

### Step 20:

The server regenerates or augments prompt sentences using emotion-aware parameters when additional content is needed.
Input: The server uses the current emotional state from Step 18, user preferences from earlier steps, and previously generated story context from the page-structure data.
Processing: When the user requests continuation or expansion of the story, the server constructs a new prompt sentence that includes not only the type of content and target age but also conditions that reflect the emotional state and specific story elements to emphasize or de-emphasize. The server, for example, adds clauses such as “keep the tone bright and comforting for a slightly scared 3-year-old child” or “extend the role of the friendly dragon introduced earlier.” The server then proceeds again through Steps 5 to 11 for the new content, thereby creating additional pages that are consistent with the ongoing emotional and linguistic context.
Output: The server produces emotion-aware prompt sentences and corresponding newly generated text data, which are integrated into the existing page-structure data and displayed by the terminal in subsequent reading sessions.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented story generation systems, including those that leverage generative AI models, typically treat user inputs such as genre and age as static parameters and produce one-off narrative outputs without deep integration of user emotion signals or structured story elements at the system level. In such systems, the server often passes a simple, flat prompt to a generative AI model and directly returns the generated text to a client device, with little or no intermediate control over the internal composition of the prompt, the narrative structure, or the emotional alignment of the resulting content. As a result, these systems exhibit several technical deficiencies.

First, conventional systems lack a systematic mechanism at the processor level to encode multi-dimensional control information such as classification information (type of narrative), target age information, structured component information (actor, background, development), and emotion information into a prompt sentence in a way that reliably steers the generative AI model. The prompt is usually manually or heuristically constructed, which makes it difficult for the processor to ensure that the generative AI model consistently produces narrative text that matches an intended age-appropriateness profile, narrative structure, or emotional tone. This leads to unstable output characteristics and increases the need for downstream filtering or manual curation.

Second, conventional systems are not configured to use emotion information as a first-class control signal at multiple stages of the processing pipeline. Emotion signals, when used at all, are often only used as a high-level label or for post-hoc tagging. There is no integrated processor logic that (i) acquires emotion information from a user or via emotion analysis, (ii) derives emotion characteristic information from narrative text using an emotion engine, and (iii) uses both emotion information and emotion characteristic information to change or reconstruct narrative elements in a deterministic and repeatable manner. This limitation prevents the server from technically controlling the behavior of the generative AI model and the narrative post-processing steps based on real-time emotion feedback, and thereby limits the ability of the system to dynamically adapt and stabilize the narrative output.

Third, conventional systems typically do not employ probabilistic selection of structured component information, combined with prompt reconstruction, to guarantee narrative variability at the system level for identical high-level conditions. Even if a generative AI model is stochastic internally, the server does not explicitly manage randomness at the level of story components and prompt design. This makes it difficult for the processor to ensure that, under the same classification information and target age information, the system produces substantially different narrative instances on successive runs, while still respecting age and emotion constraints.

Fourth, conventional systems often deliver generated stories as monolithic text, without a server-side page structure representation that binds narrative segments to visual information in a way that is driven by classification information, target age information, component information, and emotion information. As a consequence, visual presentation on the user terminal is handled in an ad-hoc manner, and cannot be systematically adapted to the user's emotional state or preferences. This limits the ability of the system to provide a technically improved, dynamic narrative experience that integrates textual and visual content under unified server control.

Accordingly, there is a need for a computer-implemented system in which a processor is specifically configured to (1) generate condition information from classification and target age information received from a user terminal; (2) construct and update a prompt sentence for a generative AI model based on that condition information, structured component information, and emotion-related information; (3) obtain narrative text from the generative AI model; (4) perform emotion recognition or emotion analysis on the narrative text using an emotion engine; (5) change or reconstruct wording, component information, or development patterns in the narrative text to generate emotion-adapted narrative information; (6) probabilistically select component information in accordance with emotion information and emotion characteristic information to ensure variability across generations; and (7) divide the emotion-adapted narrative information into multiple display units, associate visual information with each display unit, and provide page structure information to a user terminal.

By implementing these operations in the processor, the system can improve the way in which the computer controls a generative AI model, manages narrative content, and produces dynamic, emotion-adapted story experiences, thereby improving the operation of the overall computer-based storytelling system itself.

The specific processing by the specific processing unit 290 of the data processing device 12 in Application Example 2 is realized by the following means.

The present invention provides a server comprising a processor configured to receive, from a user terminal, input information including classification information and target age information, to generate condition information including the classification information and the target age information, to generate, based on the condition information, on component information including at least one of actor information, background information, and development information, and on emotion information obtained from a user or from emotion analysis processing, a prompt sentence that instructs a generative AI model to generate narrative text, to transmit the prompt sentence to the generative AI model and obtain narrative text information generated by the generative AI model, to execute emotion recognition processing or emotion analysis processing on the narrative text information by using an emotion engine to obtain emotion characteristic information, to generate emotion-adapted narrative information by changing or reconstructing at least one of wording, the component information, and a development pattern in the narrative text information based on the emotion characteristic information and the emotion information, to perform probabilistic selection processing on at least one item of the component information in accordance with the emotion information and the emotion characteristic information so that narrative text information corresponding to identical classification information and target age information differs each time it is generated, and to divide the emotion-adapted narrative information into a plurality of display units, associate visual information with each display unit so as to form page structure information, and transmit electronic display data including the page structure information and the visual information to the user terminal. This enables the computer system to more precisely control the behavior of the generative AI model, to automatically adapt narrative content and visual presentation to user emotion and preferences, and to consistently produce dynamic, varied, and age-appropriate narrative experiences in a technically structured and repeatable manner.

The term “processor” refers to a hardware or software processing unit, or a combination thereof, that executes instructions to perform data processing operations, including receiving input information, generating prompt sentences, invoking a generative AI model, processing narrative text, performing emotion-related analysis, and generating output data.

The term “user terminal” refers to an information processing apparatus operated by a user, such as a mobile communication device, a tablet device, a desktop device, or a web-enabled client device, that transmits input information to the server and receives and displays narrative content.

The term “classification information” refers to information indicating a category or type of narrative content, such as a genre, theme, or other content class used to determine narrative characteristics.

The term “target age information” refers to information indicating an intended age range or age group for which the narrative content is designed, and which is used to control difficulty, vocabulary, and content suitability.

The term “condition information” refers to composite information generated from at least classification information and target age information, and optionally including other control parameters, that is used by the processor to construct a prompt sentence for a generative AI model.

The term “component information” refers to structured information representing at least one element of a narrative, including actor information, background information, and development information, which is used to control the internal structure and content of the narrative.

The term “actor information” refers to data indicating an appearance entity in a narrative, such as a main character, supporting character, or other narrative subject, without limitation to any particular character type.

The term “background information” refers to data indicating a narrative setting, environment, or context in which events of the narrative occur, such as location, time, or situational conditions.

The term “development information” refers to data indicating a narrative development pattern, including plot structure, progression of events, or story arc, which defines how the narrative evolves over time.

The term “emotion information” refers to data representing an emotional state associated with a user, including but not limited to joy, sadness, surprise, fear, or calmness, which may be obtained from explicit user input, sensor data, or emotion analysis processing.

The term “emotion analysis processing” refers to processing that analyzes data such as image data, audio data, or text data to infer an emotional state or emotional attributes, using one or more algorithms, models, or external services.

The term “emotion engine” refers to a software or hardware component, or a combination thereof, configured to perform emotion recognition processing or emotion analysis processing on input data and to output emotion characteristic information.

The term “emotion characteristic information” refers to information generated by the emotion engine that represents one or more emotional attributes of narrative text or user-related data, such as type, intensity, or polarity of emotion.

The term “prompt sentence” refers to a text-based instruction or query generated by the processor and provided to a generative AI model, which specifies conditions, constraints, or guidance for generating narrative text.

The term “generative AI model” refers to an artificial intelligence model, such as a neural network-based language model, configured to generate narrative text or other content based on input text including a prompt sentence.

The term “narrative text information” refers to text data output by the generative AI model in response to a prompt sentence, representing a story, narrative, or similar content.

The term “emotion-adapted narrative information” refers to narrative text information that has been changed or reconstructed by the processor based on emotion information and emotion characteristic information so that wording, component information, or development patterns are adapted to an emotional state.

The term “probabilistic selection processing” refers to processing in which at least one item of component information is selected according to a random or pseudo-random algorithm, optionally weighted by parameters such as emotion information or emotion characteristic information, to produce varied narrative outputs.

The term “display unit” refers to a unit segment of narrative content, such as a page, screen, or section, which is treated as a discrete unit for display on a user terminal.

The term “visual information” refers to non-textual data such as image data, illustration data, or graphic data that is associated with a display unit of narrative content for visual presentation.

The term “page structure information” refers to structured data defining an arrangement of multiple display units, including their associated narrative text information and visual information, to form a multi-unit electronic presentation.

The term “electronic display data” refers to data formatted for display on a user terminal, including page structure information, narrative text information, and visual information, which is transmitted from the server to the user terminal.

The term “dynamic narrative experience” refers to a user experience in which narrative content and associated visual presentation are varied or adapted over time, including across different generations or readings, based on factors such as classification information, target age information, component information, emotion information, or emotion characteristic information.

In one embodiment, a server, a user terminal, and a communication network cooperate to implement a system that generates, adapts, and delivers emotion-aware narrative content by controlling a generative AI model using structured prompt sentences and post-processing logic. The server executes one or more software programs on a computing platform comprising at least one processor, a main memory, a non-volatile storage device, and a network interface. The user terminal comprises at least a processor, a display device, an input device, and optionally a camera and a microphone.

The server executes an application program implemented, for example, using a general-purpose programming language such as Python in combination with a web framework such as a conventional web application framework. The server uses a data storage subsystem implemented by a general-purpose database system, such as a relational database management system or a cloud-based document store, to store classification information, target age information, component information (actor information, background information, and development information), visual information, and user interaction logs. The server uses a generative AI model implemented as a neural network-based language model, such as a transformer architecture trained for natural language generation, which is accessible either as a locally deployed model or as a cloud-hosted model through an application programming interface.

The user terminal executes a client application, which can be implemented as a web browser application using hypertext markup language and a scripting language, or as a native application of a mobile operating system. The terminal presents to the user an interface for providing classification information, target age information, and optional component information. The terminal renders interactive controls, such as menus, buttons, and selection lists, and captures user selections. The terminal further captures, when permitted, sensor data such as images of the user's face via a camera, and audio data via a microphone. The terminal then transmits structured input information to the server through a communication network using a protocol such as HTTPS.

The server receives, stores, and processes the input information. The server converts the input information into internal data structures, such as records containing fields for classification information, target age information, and references to component information. The server maintains separate database tables or collections for actor information, background information, development information, visual information, and emotion-related data. The server associates identifiers with each element and uses foreign key relationships so that a narrative instance can be represented as a collection of references to these elements plus textual content segments.

The server implements an emotion engine. The emotion engine may be realized as a combination of externally provided emotion recognition services and locally executed models. For example, the server uses an image analysis model, which may be a convolutional neural network, to infer emotion labels from facial images received from the terminal. The server also uses an audio analysis model or a text sentiment analysis model to infer emotion from voice or textual feedback. The server may call external emotion recognition APIs as part of this process and normalize their outputs into a unified emotion characteristic representation, such as a vector of emotion classes (joy, sadness, surprise, etc.) and corresponding confidence scores. The server stores this emotion characteristic information alongside user session data.

The server controls the generative AI model through a prompt sentence. The server constructs the prompt sentence by concatenating classification information, target age information, component information, and emotion-related information into a natural language instruction string. The server uses deterministic templates and rule-based assembly logic to ensure that each field is expressed in a consistent and machine-controllable manner. For example, the server generates prompt sentences such as:
“Please generate an adventure story for a 5-year-old child about a friendly pirate on a mysterious island, with a joyful tone and a happy ending.”
“Genre: adventure. Age: 10. Character: pirate. Setting: treasure hunt on a mysterious island. Plot: dangerous cave exploration. Please generate an exciting but age-appropriate adventure story for a 10-year-old reader, with a positive ending.”
“Fantasy story for a 5-year-old child. The child is currently feeling happy. Please generate a joyful, gentle story about a young wizard and friends exploring a magic forest, with simple language and a clearly positive ending.”

The server, in order to guarantee variability and technical control, does not simply reuse a fixed prompt template. The server performs probabilistic selection of component information for each narrative generation. For example, the server uses a pseudo-random number generator to select, from the database, an actor, background, and development pattern, subject to constraints imposed by classification information, target age information, and emotion characteristic information. The server may weight particular components more heavily when certain emotions are detected, thereby embedding decision logic that is not trivially equivalent to human manual selection. By encoding these selected components into the prompt sentence, the server ensures that even for the same classification and age, the prompt sentence differs in structure and content in a controlled, algorithmic way.

The generative AI model used by the server can be implemented as a transformer-based neural network language model with multiple attention layers, embedding layers, and feed-forward layers. The model is trained on large-scale text corpora using an unsupervised or semi-supervised learning paradigm, where the objective function minimizes prediction error of the next token over a sequence. In training, the model uses gradient-based optimization, such as stochastic gradient descent with variants like Adam or similar optimizers, and a loss function such as cross-entropy between predicted token distributions and ground truth tokens.

The server, or a training system, performs iterative updates of model parameters based on backpropagated gradients. Training may employ data augmentation strategies, such as random masking or context-window shuffling, to improve robustness. The deployed model may be a pre-trained model optionally fine-tuned on narrative datasets that include labels for age-appropriate content or emotional tone.

The server, when executing the generative AI model at inference time, sets generation parameters such as temperature, top-k, or nucleus sampling thresholds to achieve a balance between coherence and diversity. The server transmits the prompt sentence and generation parameters to a model-serving component, which converts the prompt sentence into tokens, feeds the token sequence through the transformer layers, and outputs a probability distribution over possible next tokens at each generation step. The model-serving component then samples tokens according to the specified sampling algorithm until an end-of-text condition is met. The generated token sequence is converted back into text and returned to the server as narrative text information.

The server performs post-processing on the narrative text information. The server applies natural language processing modules, such as text segmenters, sentence complexity analyzers, and lexical filters. The server can employ additional neural network modules or statistical models to check and adjust reading difficulty based on target age information, using features such as sentence length, word frequency statistics, and syntactic structure. The server also applies the emotion engine to the generated narrative text, extracting emotion characteristic information such as overall sentiment polarity and intensity, and possibly per-segment emotion trajectories.

The server compares the emotion characteristic information from the generated narrative text with the target emotion information derived from user inputs or sensor-based emotion analysis. When discrepancies exist, the server adjusts the narrative. The server can construct a second-stage prompt sentence, such as:
“Please revise the previous story to be less scary and more joyful for a 5-year-old child, using shorter sentences and a clearly happy ending.”

The server sends this second-stage prompt sentence to the generative AI model together with the original narrative text or a summary of it. The generative AI model then generates a revised narrative. Alternatively, the server directly modifies certain narrative segments using rule-based text operations, such as replacing words from a predefined lexicon of emotionally negative expressions with neutral or positive synonyms. This rule-based layer is specifically designed to operate on machine-readable data structures, which enables the server to consistently achieve an emotion-adapted narrative output without requiring manual human editing.

The server constructs page structure information by dividing the emotion-adapted narrative information into display units. The server determines segmentation points based on text length, sentence boundaries, and narrative structure markers. For each display unit, the server selects visual information from a repository that stores multiple image candidates associated with actor types, backgrounds, and emotional tones. For example, when the narrative involves a pirate in a joyful context, the server prioritizes bright-colored pirate illustrations, whereas when the narrative involves a mysterious forest, the server chooses darker, atmospheric forest images. The server uses metadata tags on images, which encode character type, setting, and mood, to perform this matching efficiently using indexed lookups.

The server formats the page structure information and visual information into electronic display data suitable for the user terminal. For example, the server encodes the structure in a markup language or a structured data format, specifying page order, text blocks, image references, and style attributes. The server may additionally compress or optimize the data, such as reducing image resolution based on terminal capabilities or network conditions, thereby decreasing transmission time and improving responsiveness. The server then transmits the electronic display data to the user terminal via the network interface.

The user terminal receives the electronic display data, parses the structure, and renders the pages on the display device. The terminal may implement efficient caching strategies for visual information to reduce repeated downloads when similar characters or backgrounds appear in multiple stories. The terminal presents page navigation controls and may animate transitions, thus providing a coherent picture-book-like reading experience. The terminal can also continue to capture emotion-related data during reading, which is sent back to the server for further adaptation in future generations, making the narrative experience dynamic over time.

This system provides technical improvements to computer technology itself. The server improves control over generative AI model behavior by introducing structured condition information, probabilistic component selection, and multi-stage emotion-based adaptation.

The server thereby reduces the need for repeated calls to the generative AI model that would otherwise be used to manually search for an acceptable story, which in turn reduces network traffic and server load. The structured prompt construction and post-processing stage, operating on well-defined data structures, also yield more predictable model outputs, reducing error rates related to inappropriate content or mismatched emotional tone.

The server's use of probabilistic selection of component information at the database level, combined with deterministic rule-based encoding into the prompt sentence, results in a non-conventional processing pipeline that is not merely automating human story-writing behavior.

Instead, the server creates an explicit mapping from high-level control signals (classification, age, emotion) to low-level generative model inputs and outputs, through intermediate data structures and algorithms specifically designed for machine consumption. This pipeline improves computational efficiency, because narrative variability is controlled at the level of component selection and prompt design rather than solely by brute-force sampling from the generative model.

The inclusion of an emotion engine that analyzes both user signals and narrative text, and that feeds back emotion characteristic information to the narrative generation and restructuring logic, produces a closed-loop control system for narrative content. This loop is implemented via machine-readable data structures and algorithmic steps, which enhances the technical reliability of the system. The server does not simply display user emotion as metadata; instead, the server uses emotion information to weight database queries, modify prompt sentence content, adjust neural network sampling parameters, and select visual information.

This tight integration of emotion signals into core processing paths provides a concrete improvement in output alignment and reduces mismatches between user state and system output.

From the perspective of model training and maintenance, the server can log associations between input condition information, prompt sentences, generated narrative text, emotion characteristic information, and user feedback. These logs can be used to fine-tune the generative AI model or to train auxiliary models, such as age-appropriateness classifiers or emotion alignment scorers. The server can use supervised learning on these logs to adjust model weights using gradient descent and loss functions that penalize misalignment between target and actual emotional tone or reading difficulty. Through this continuous adaptation, the server can gradually increase the accuracy and stability of narrative generation for particular user profiles or device environments.

Alternative embodiments may adjust the system architecture. In one variation, the generative AI model is deployed on the same physical machine as the server; in another variation, the generative AI model is hosted on a remote inference service. In yet another variation, the emotion engine is entirely local to the server and implemented as a set of pre-trained neural networks, while in another, it relies on external cloud-based analytics. Component information may be stored either in a relational schema or in a graph database that represents relationships among characters, settings, and plots. Visual information may be static images, vector graphics, or even animated sequences.

In further embodiments, the server may support multiple languages, using different generative AI models or multilingual models, with prompt sentences and narrative text processed in various languages. The server may also adapt page structure information based on terminal characteristics, such as screen size and orientation, by modifying segmentation and layout strategies accordingly. The underlying technical principles remain the same: the server constructs structured prompt sentences, controls a generative AI model via these prompts, analyzes and adapts narrative text with emotion-aware logic, and generates data structures that define dynamic, visually supported narrative presentations on the user terminal.

By implementing these mechanisms, the system achieves specific technical effects: increased precision in controlling AI-generated narrative content, reduced computational overhead for generating multiple suitable stories, improved alignment between user emotion and displayed content, more efficient storage and retrieval of narrative and visual components, and more predictable data flows and machine behavior. These effects arise from the particular combination of structured data representations, algorithmic component selection, emotion-aware prompt generation, transformer-based neural network inference, and server-side post-processing that together improve the functioning of the computer-based storytelling system beyond mere automation of human creative tasks.

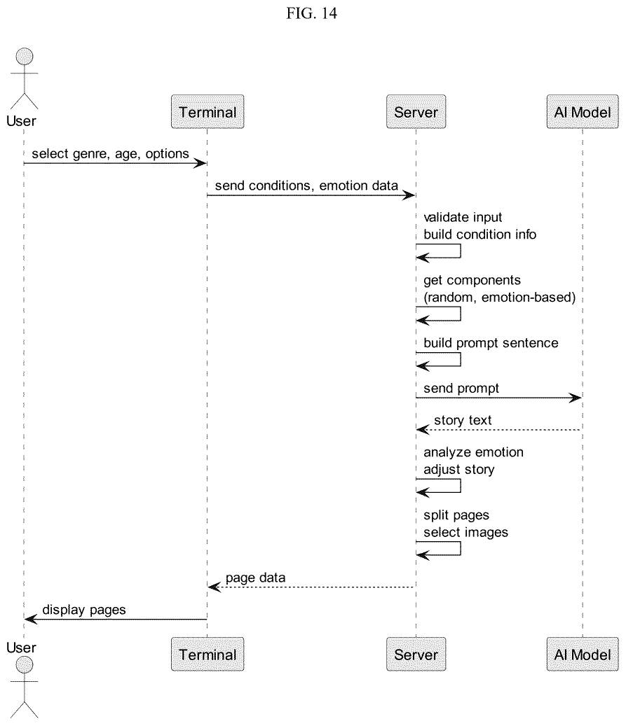

The following describes the processing flow using FIG. 14.

### Step 1:

User operates the terminal to provide initial narrative conditions.
User selects, on the terminal's user interface, at least classification information (for example, a story genre) and target age information (for example, an age or age range). User may further select optional component information such as actor information, background information, and development information from lists or icons.
Input: User's selections entered via graphical controls on the terminal (buttons, drop-down lists, sliders, etc.).
Output: A structured set of initial conditions stored in the terminal's memory, including classification information, target age information, and any selected component information.

### Step 2:

Terminal acquires optional emotion-related data from the user.
Terminal activates hardware sensors such as a camera and a microphone, with the user's permission, and captures image data of the user's face and audio data of the user's voice while the user interacts with the interface or reads prior content. Terminal may also capture explicit emotion labels if the user selects them from an on-screen list.
Input: Raw sensor data (image frames, audio samples) and/or explicit user-entered emotion labels.
Output: Emotion-related input data stored in the terminal's memory and prepared for transmission, including sensor data references or encoded emotion labels.

### Step 3:

Terminal transmits user input data to the server.
Terminal constructs a request message that includes the initial conditions (classification information, target age information, and any component information) and the emotion-related input data. Terminal encodes this information into a structured format and sends the message to the server over a network connection using a communication protocol.
Input: Structured initial conditions and emotion-related input data held in the terminal.
Output: A network request delivered to the server, containing the user's narrative conditions and emotion-related input data.

### Step 4:

Server receives and validates the user input data.
Server parses the received request message and converts it into internal data structures.
Server checks the validity of the classification information and target age information, verifies that component information values are known or fillable, and normalizes emotion-related input into a standard internal representation or marks it as absent.
Input: Network request including classification information, target age information, component information, and emotion-related input data.
Output: Validated and normalized condition information and preliminary emotion information stored in the server's memory as structured records.

### Step 5:

Server derives or refines emotion information using an emotion engine.
Server, when emotion-related sensor data is included, forwards image and audio data to an emotion engine that may include one or more trained models and external emotion recognition services. Server executes algorithms that analyze facial features, voice characteristics, and any explicit emotion labels to infer emotion information. Server converts these results into emotion characteristic information, such as emotion type and intensity.
Input: Raw or preprocessed emotion-related data and explicit emotion labels.
Output: Refined emotion information and emotion characteristic information, represented as machine-readable fields associated with the user session.

### Step 6:

Server retrieves candidate component information from a database.
Server queries a database storing actor information, background information, and development information that are indexed by classification information, target age information, and other constraints. Server filters the results so that only age-appropriate and genre-consistent elements are included.
Input: Validated classification information, target age information, and any specified component constraints.
Output: One or more sets of candidate component information, each including actor information, background information, and development information suitable for the given classification and age.

### Step 7:

Server selects component information using probabilistic selection.
Server performs probabilistic selection processing on the candidate component information.
Server uses a pseudo-random algorithm, optionally weighted by emotion information and emotion characteristic information, to choose one or more specific actors, backgrounds, and development patterns. Server thereby forms a concrete set of component information for the current narrative instance.
Input: Candidate component information sets and emotion-related parameters.
Output: Selected component information for this generation, including at least one actor, one background, and one development pattern stored as a structured record.

### Step 8:

Server constructs a prompt sentence for the generative AI model.
Server composes a prompt sentence by inserting the classification information, target age information, selected component information, and emotion-related parameters into a template. Server performs string concatenation and formatting operations so that the resulting sentence is a coherent natural language instruction that includes explicit constraints. For example, server generates:
“Please generate an adventure story for a 5-year-old child about a friendly pirate on a mysterious island, with a joyful tone and a happy ending.”
   or
“Genre: adventure. Age: 10. Character: pirate. Setting: treasure hunt on a mysterious island. Plot: dangerous cave exploration. Please generate an exciting but age-appropriate adventure story for a 10-year-old reader, with a positive ending.”
Input: Condition information (classification and age), selected component information, and emotion-related parameters.
Output: A prompt sentence stored as a text string ready for submission to the generative AI model.

### Step 9:

Server invokes the generative AI model with the prompt sentence.
Server transmits the prompt sentence, along with generation parameters such as maximum length and sampling settings, to a generative AI model implemented as a neural network language model. Server initiates inference by passing the prompt sentence tokens through the model. The model executes mathematical operations in its layers to compute probability distributions over next tokens and samples a sequence of tokens to form narrative text.
Input: Prompt sentence and generation parameters.
Output: Narrative text information generated by the generative AI model, returned to the server as a text sequence.

### Step 10:

Server performs initial processing on the narrative text information.
Server segments the narrative text into sentences and paragraphs, evaluates its length, and checks for the presence of required elements such as mentions of the selected actor, background, and development patterns. Server may remove extraneous content or enforce simple structural constraints, such as adding a title line or ensuring a closing sentence.
Input: Raw narrative text information received from the generative AI model.
Output: Cleaned and structurally normalized narrative text information stored in the server's memory.

### Step 11:

Server analyzes the narrative text with the emotion engine.
Server passes the normalized narrative text to the emotion engine, which evaluates the emotional tone and trajectory of the text. Server receives emotion characteristic information, such as overall sentiment and dominant emotions, and optionally segment-level emotion profiles. Server compares these characteristics with the target emotion information derived from user inputs.
Input: Normalized narrative text information and target emotion parameters.
Output: Emotion characteristic information for the narrative text and a comparison result indicating alignment or misalignment with the target emotion.

### Step 12:

Server adjusts the narrative text based on emotion alignment.
Server, when misalignment is detected, modifies the narrative text by either generating a revised version or editing the existing version. Server may generate a second-stage prompt sentence, such as:
“Please revise the previous story to be less scary and more joyful for a 5-year-old child, using shorter sentences and a clearly happy ending.”
and submit this, along with the original story, to the generative AI model to obtain an adjusted narrative. Alternatively, server may replace or remove specific terms using a lexicon-driven rule set.
Input: Original narrative text, emotion characteristic information, and target emotion parameters.
Output: Emotion-adapted narrative information in which wording, component emphasis, or development patterns are changed to better match the target emotion.

### Step 13:

Server segments the emotion-adapted narrative into display units.
Server divides the emotion-adapted narrative information into multiple display units based on page length criteria, such as a maximum number of characters or sentences per page, and narrative boundaries like paragraph breaks. Server assigns each segment a display unit identifier and page order index.
Input: Emotion-adapted narrative information in text form.
Output: A sequence of display units, each containing a portion of the narrative text and associated metadata such as page index.

### Step 14:

Server selects visual information for each display unit.
Server queries a visual asset repository for images or other visual materials tagged with actor types, backgrounds, and emotional attributes. Server correlates tags with the component information and emotion-related parameters for each display unit. Server selects the most appropriate visual information for each display unit using matching algorithms and stores references to the chosen assets.
Input: Display units, component information, and emotion-related parameters.
Output: Page structure information in which each display unit is associated with selected visual information references.

### Step 15:

Server generates electronic display data for the user terminal.
Server combines the page structure information, narrative text segments, and visual information references into a structured representation suitable for rendering on the terminal.
Server may include layout directives such as text position, image size, and style attributes.
Server then prepares a response payload that encodes this electronic display data.
Input: Page structure information with text and visual references.
Output: Electronic display data formatted for transmission to the user terminal.

### Step 16:

Server transmits the electronic display data to the terminal.
Server sends the prepared response payload over the network to the terminal using a communication protocol. Server may segment large payloads into smaller parts or apply compression to reduce transmission time.
Input: Electronic display data stored on the server.
Output: A response message containing the electronic display data delivered to the terminal.

### Step 17:

Terminal renders the narrative and visual content for the user.
Terminal receives the electronic display data and parses the page structure, text, and visual references. Terminal retrieves any referenced images, either from a server or from a local cache, and composes each page on the display. Terminal presents navigation controls, such as swipe gestures or next/previous buttons, to allow the user to move between display units.
Input: Electronic display data received from the server and associated visual resources.
Output: A sequence of graphical pages displayed on the terminal's screen, each page showing narrative text and corresponding visual information.

### Step 18:

User experiences and optionally reacts to the presented story.
User reads the displayed narrative and views the associated visuals. User may navigate through pages, provide feedback via buttons or forms, or initiate another story generation request by changing classification information, age, or other conditions. User reactions can generate new input data for further processing by the terminal and server.
Input: Visual and textual content displayed on the terminal and any user feedback controls.
Output: User interactions and new control inputs, which can be fed back into Step 1 and subsequent steps for iterative narrative generation and adaptation.

The data generation model 58 is a so-called generative artificial intelligence (AI).

Examples of the data generation model 58 include generative AIs such as ChatGPT (registered trademark) (Internet search <URL: https://openai.com/blog/chatgpt>) and the like.

The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

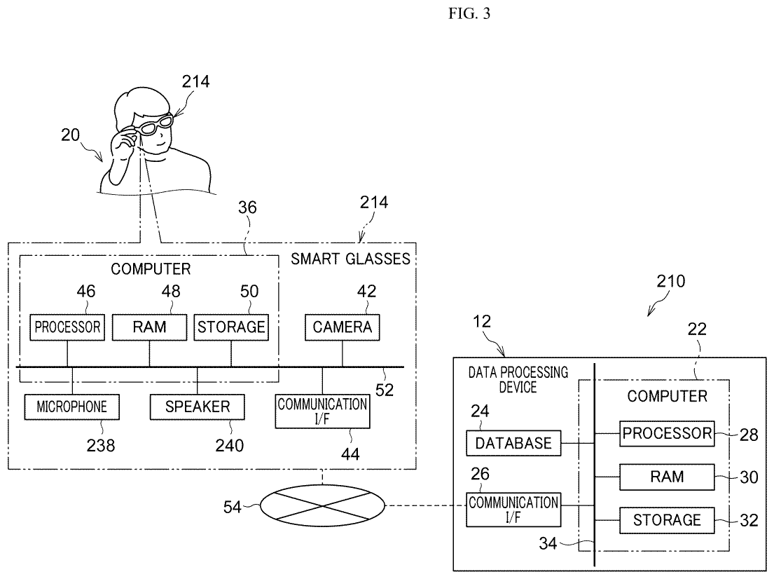

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52.

The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

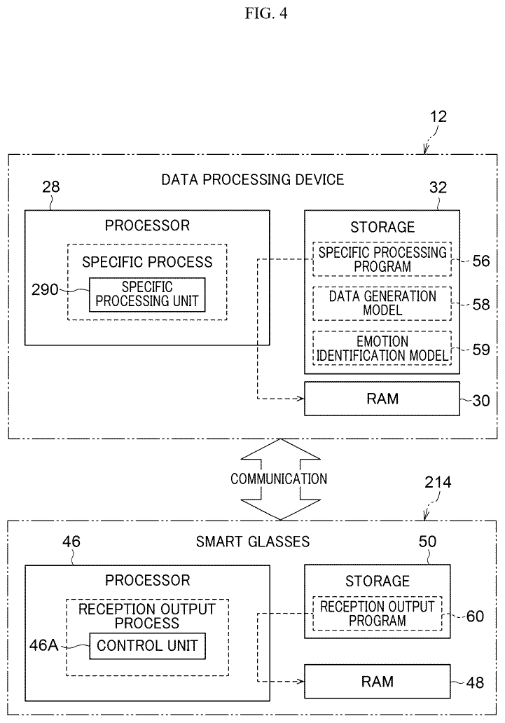

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples.

Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI).

Examples of the data generation model 58 include generative AIs such as ChatGPT (registered trademark) (Internet search <URL: https://openai.com/blog/chatgpt>) and the like.

The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

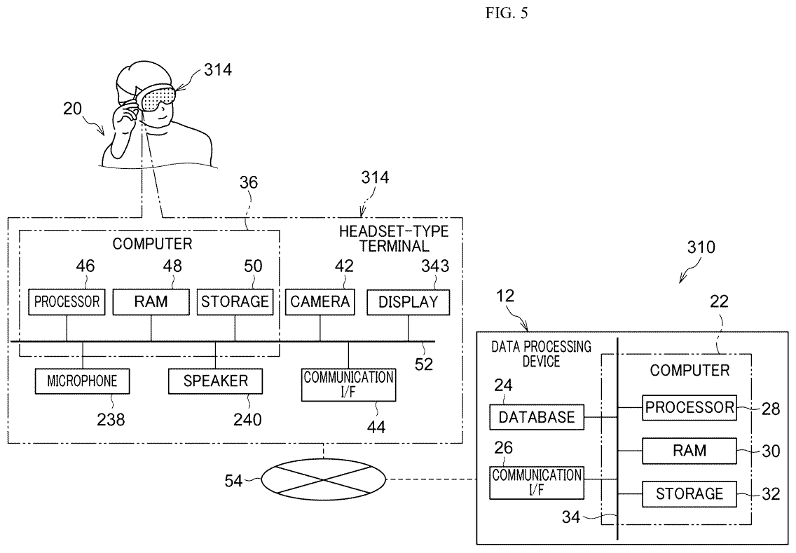

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

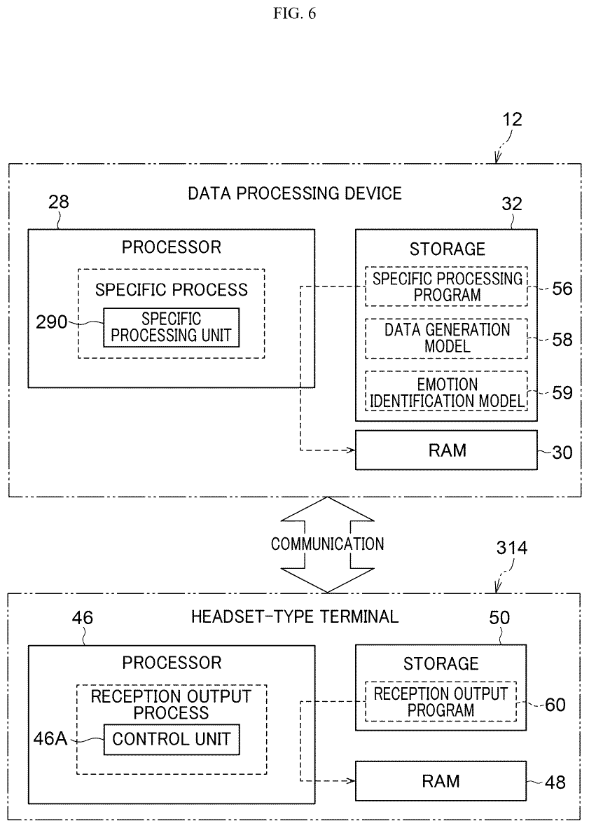

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314.

In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI).

Examples of the data generation model 58 include generative AIs such as ChatGPT (registered trademark) (Internet search <URL: https://openai.com/blog/chatgpt>) and the like.

The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12.

For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

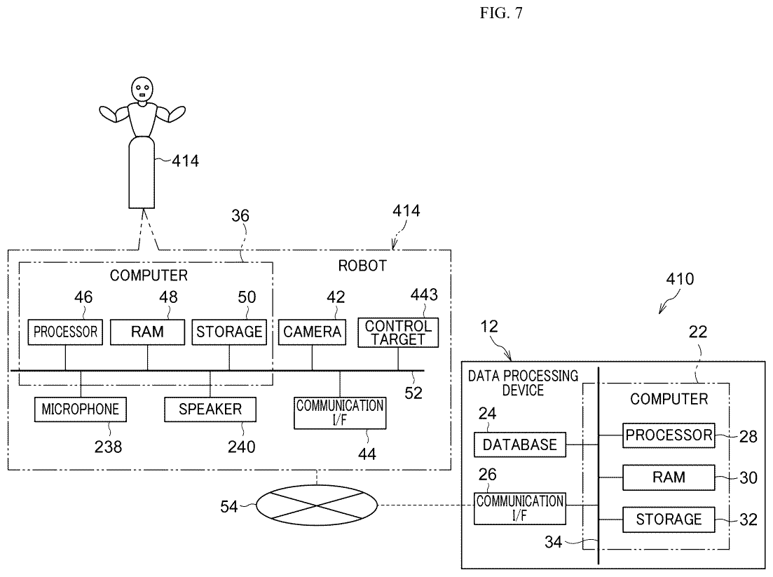

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

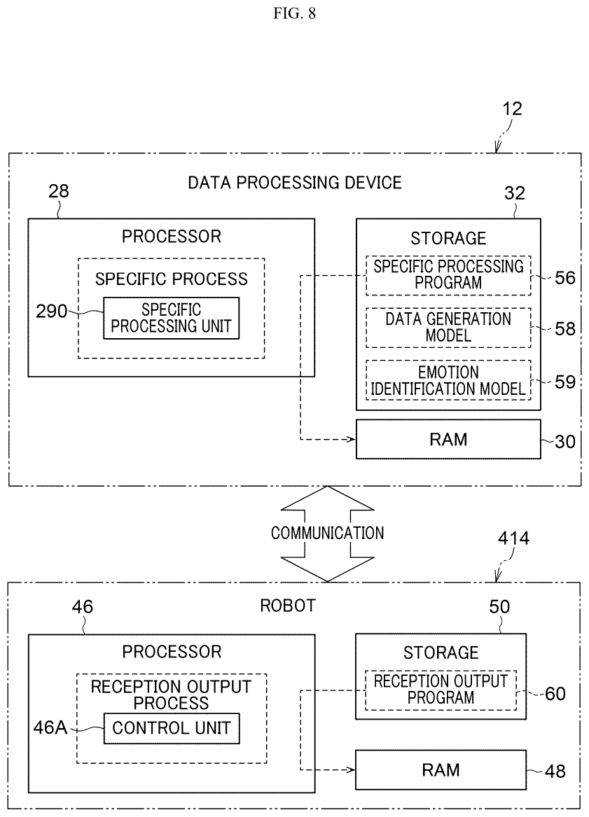

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414.

A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI).

Examples of the data generation model 58 include generative AIs such as ChatGPT (registered trademark) (Internet search <URL: https://openai.com/blog/chatgpt>) and the like.

The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

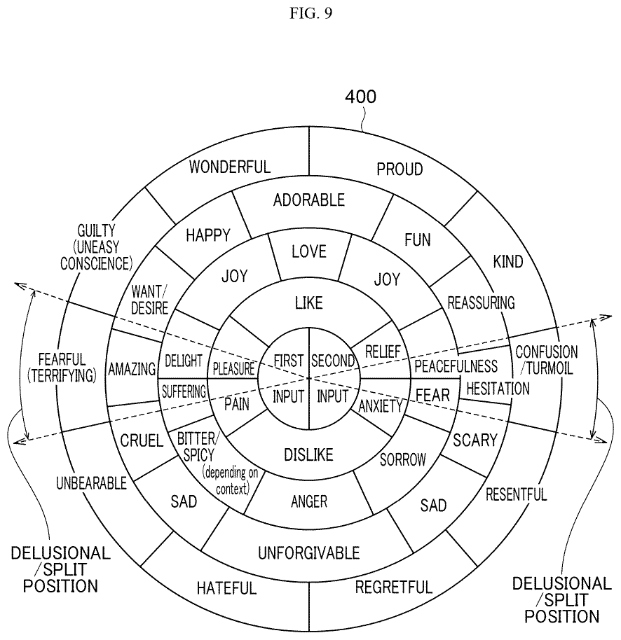

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center.

Primitive states of emotion are arranged nearer to the center of the concentric circles.

Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety.

Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University).

Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot.

Another is a positive emotion in the area of “desire” on the reaction side. In other words, there are times when a positive feeling such as “desire more” and “want to know more” is experienced.

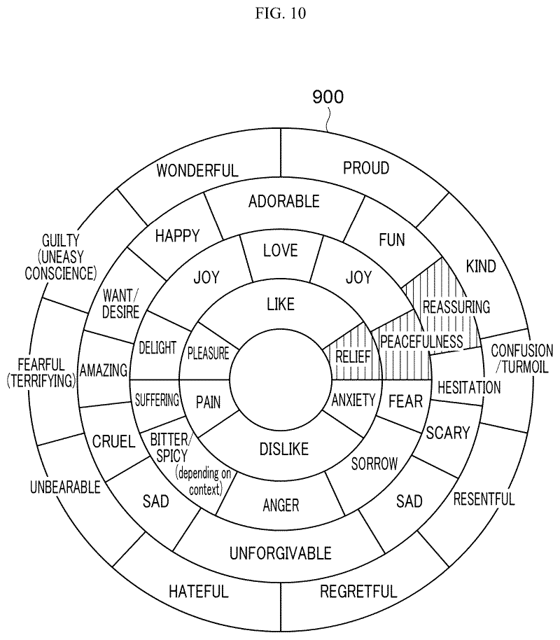

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like.

The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC).

Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure.

This means that obviously redundant parts may be eliminated, new elements may be added, and switching around may be performed on the described content and drawing content illustrated above within a range not departing from the spirit of the present disclosure.

Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
control a display device and an input device so that a user is enabled to select at least one content category and at least one target age range from among a plurality of content categories and a plurality of target age ranges, and to acquire selection information corresponding to the selected content category and the selected target age range,
extract condition information including the content category and the target age range from request information transmitted via a communication network from a terminal, and
automatically generate, by performing character string processing on the condition information, a prompt sentence expressed in natural language,
input the automatically generated prompt sentence into a generative information processing model, and cause the generative information processing model to generate content data including story information by performing probabilistic calculation processing based on the prompt sentence,
input the generated content data into an emotion estimation processing unit that estimates an emotional state of the user, and perform content adjustment processing for changing story components or an expression format within the content data on the basis of an emotion estimation result obtained by the emotion estimation processing unit, and
transmit the content data after the content adjustment processing to the terminal via the communication network, and cause the display device of the terminal to output the content data after the content adjustment processing in a format visually presentable to the user.

### Supplementary 2

The system according to supplementary 1,
wherein the processor is configured to control the content adjustment processing so that, in response to the emotional state of the user estimated by the emotion estimation processing unit, characters, events, and a development order of the story in the content data are reconfigured, and the content data is sequentially changed in accordance with a change in the emotional state of the user.

### Supplementary 3

The system according to supplementary 1,
wherein the processor is configured to generate the prompt sentence such that, on the basis of the condition information including the content category, the target age range, and the emotional state estimated by the emotion estimation processing unit, a subject of illustrative information and attribute information of characters are automatically selected, and the subject and the attribute information of the characters are reflected in the story information generated by the generative information processing model.

### Application Example 1

### Supplementary 1

A system comprising a processor,
wherein the processor is configured to
provide, to a user via a display unit and an operation unit of an information processing terminal, a user input/output interface that enables the user to select and input an information category and an age group,
convert the information category and the age group acquired from the user input/output interface into a structured data format, automatically generate, on the basis of the structured data, a natural-language prompt sentence corresponding to the information category and the age group, and transmit the prompt sentence to a generative AI model included in a generative information processing model disposed internally or externally to the system,
receive, from the generative AI model, a character information sequence output in response to the prompt sentence in a sequential or batch manner, and perform post-processing on the character information sequence, the post-processing including at least one of formatting, phrase filtering, and segmentation/combination, so as to shape the character information sequence into visual-presentation information,
transmit the visual-presentation information, by a streaming scheme or a batch scheme, to a visual display apparatus including at least one of a portable information terminal and a wearable display device, and cause the visual display apparatus to sequentially display the visual-presentation information,
receive, via the visual display apparatus, a regeneration instruction or a condition-change instruction from the user who has visually recognized the visual-presentation information, and, in response to the regeneration instruction or the condition-change instruction, re-execute automatic generation of the prompt sentence and transmission of the prompt sentence to the generative AI model, and
analyze the character information sequence output from the generative AI model by using an emotion estimation processing unit that changes the character information sequence on the basis of state information of the user, and, in accordance with the state information, selectively add, delete, or modify constituent elements of the character information sequence so as to adjust the visual-presentation information.

### Supplementary 2

The system according to supplementary 1,
wherein the processor is configured to control the character information sequence to dynamically change according to the state information of the user, by causing the emotion estimation processing unit to reconfigure at least a part of constituent elements including appearing entities, scene settings, and story developments on the basis of the state information of the user acquired during presentation of the visual-presentation information.

### Supplementary 3

The system according to supplementary 1,
wherein the processor is configured to, before the automatic generation of the prompt sentence, automatically select, on the basis of the information category, the age group, and the state information of the user recognized by the emotion estimation processing unit, a theme of an image medium, a group of appearing entities, and a group of visual elements, and include a selection result in the prompt sentence so as to cause the generative AI model to reflect the theme, the group of appearing entities, and the group of visual elements in the character information sequence to be generated.

### Example 2

### Supplementary 1

A system comprising a processor,
wherein the processor is configured to
generate, on a user output device, an input/output screen through which a user is enabled to specify a type of content and a target age of a recipient, and to acquire the specified type of content and the specified target age via the input/output screen,
automatically generate a prompt sentence for instructing a generative AI model to generate text, by embedding the acquired type of content and the acquired target age into a predefined character-string template by character-string processing,
transmit the generated prompt sentence as a communication request to an external generative AI model providing apparatus, and receive text data output from the generative AI model in response to the prompt sentence,
process the received text data in accordance with reference information relating to vocabulary difficulty and sentence length corresponding to the target age, by dividing the text data into units of sentences or paragraphs, replacing words having a high difficulty level with words having a lower difficulty level, and splitting sentences exceeding a predetermined number of characters or a predetermined number of sentences,
divide the processed text data into a plurality of pages, automatically generate, for each page, an image description text for instructing a visual expression corresponding to the type of content and the target age, and generate page-structure data including, for each page, page text data and the image description text,
transmit the page-structure data to the user output device and cause the user output device to output the page-structure data in a display format in which page turning is possible,
acquire, from the user output device, user correction input with respect to the page-structure data, and store, in a storage device, page-structure data in which the user correction input is reflected, and
execute emotion estimation processing to estimate an emotional state of the user with respect to the generated text data, and, based on the estimated emotional state, adjust the page-structure data by changing at least a part of vocabulary, sentence structure, or page composition of the processed text data.

### Supplementary 2

The system according to supplementary 1,
wherein the processor is configured to determine the emotional state of the user on the basis of at least one of biometric information, operation-history information, and uttered-voice information acquired from the user output device, and, when the emotional state is determined to belong to a predetermined emotion category, to dynamically change the text data by reconstructing at least one of an appearing entity, a scene configuration, and an ending expression included in the page-structure data.

### Supplementary 3

The system according to supplementary 1,
wherein, in generating the page-structure data, the processor is configured to automatically select or generate, in accordance with the type of content, the target age, and the emotional state, at least a subject of the content as a whole, a type and characterization of the appearing entity, and an image description text corresponding to each page, and to add the selected or generated subject, appearing entity, and image description text as a part of the prompt sentence for the generative AI model so as to cause the subject, the appearing entity, and the image description text to be reflected in the text data.

### Application Example 2

### Supplementary 1

A system comprising a processor,
wherein the processor is configured to
receive, from a user terminal, input information including classification information indicating a type of narrative content and target age information indicating a target age range, and generate condition information including the classification information and the target age information,
automatically generate a prompt sentence for instructing a generative AI model to generate narrative text, based on the condition information and on component information including at least one of actor information indicating an appearance entity in the narrative, background information indicating a narrative setting, and development information indicating a narrative development pattern, and further based on emotion information acquired from a user or emotion information obtained by emotion analysis processing,
transmit the prompt sentence to the generative AI model and acquire narrative text information generated by the generative AI model,
execute, on the narrative text information, emotion recognition processing or emotion analysis processing by using an emotion engine to obtain emotion characteristic information, and generate emotion-adapted narrative information by changing or reconstructing, based on the emotion characteristic information and the emotion information, at least one of wording, the component information, or a development pattern in the narrative text information, and divide the emotion-adapted narrative information into a plurality of display units, associate visual information with each of the display units to form page structure information, and transmit the page structure information to the user terminal.

### Supplementary 2

The system according to supplementary 1,
wherein the processor is configured to perform probabilistic selection processing on at least one item of the component information in accordance with the emotion information and the emotion characteristic information, and to generate or update the prompt sentence so as to reflect a result of the probabilistic selection processing in the prompt sentence, such that narrative text information corresponding to identical classification information and target age information becomes different each time it is generated.

### Supplementary 3

The system according to supplementary 1,
wherein the processor is configured to automatically select or determine the visual information corresponding to each of the display units included in the page structure information, based on the classification information, the target age information, the component information, and the emotion information, and to provide, to the user terminal, electronic display data including the visual information, thereby generating a dynamic narrative experience adapted to an emotional state and a preference of a user.

What is claimed is:

1. A system comprising:
circuitry configured to:
receive, via a communication interface coupled to a packet-switched network, request data from a terminal device comprising selection data corresponding to at least one content category and at least one target age range;
extract condition data comprising the content category and the target age range from the request data, and automatically generate, by applying character string processing to the condition data, a prompt sentence expressed in natural language;
input the prompt sentence to a generative neural network model and cause the generative neural network model to generate content data comprising story information by performing probabilistic computation based on the prompt sentence;
input the generated content data to an emotion estimation processing unit that estimates an emotional state of a user, and perform content adjustment processing for modifying story components or an expression format within the content data based on an emotion estimation result; and
transmit the content data after the content adjustment processing to the terminal device via the communication interface.

2. The system according to claim 1, wherein the circuitry is configured to apply the emotion estimation processing unit to reconfigure at least one of story plot elements, character dialogue patterns, or narrative pacing within the content data based on the emotion estimation result, and generate an updated prompt sentence incorporating the emotion estimation result as an adjustment condition for a subsequent content generation cycle.

3. The system according to claim 2, wherein the circuitry is configured to select a plurality of candidate story component configurations based on the emotion estimation result, generate a plurality of candidate content data items by inputting candidate prompt sentences corresponding to the candidate story component configurations to the generative neural network model, and select a final content data item from the plurality of candidate content data items based on a coherence metric.

4. The system according to claim 3, wherein the circuitry is configured to compute the coherence metric by measuring semantic consistency between each candidate content data item and the condition data and the emotion estimation result, and select the candidate content data item with the highest coherence metric score as the final content data item.

5. The system according to claim 1, wherein the circuitry is configured to automatically select a theme and one or more character configurations based on the content category, the target age range, and the emotion estimation result, incorporate the selected theme and character configurations into the prompt sentence as generation constraints, and transmit the prompt sentence to the generative neural network model.

6. The system according to claim 5, wherein the circuitry is configured to retrieve theme data and character configuration data from a storage device indexed by a content category identifier and a target age range identifier, select a subset of the retrieved data based on the emotion estimation result, and substitute the selected subset into the prompt sentence.

7. The system according to claim 1, wherein the circuitry is configured to apply an emotion recognition algorithm to at least one of facial expression data or voice data received from the terminal device to generate the emotion estimation result, classify the emotion estimation result into one of a plurality of emotional state categories, and apply a content adjustment strategy associated with the classified emotional state category.

8. The system according to claim 7, wherein the circuitry is configured to detect a change in the emotion estimation result exceeding a state-change threshold during a content delivery session, regenerate the prompt sentence incorporating the updated emotion estimation result as an adjustment condition, and supply the regenerated prompt sentence to the generative neural network model to generate updated content data.

9. The system according to claim 8, wherein the circuitry is configured to transmit the updated content data to the terminal device during the content delivery session, and seamlessly replace currently displayed story components with updated story components based on the updated content data without interrupting the delivery session.

10. The system according to claim 1, wherein the circuitry is configured to generate the prompt sentence by selecting a prompt template based on the content category, substituting the target age range and content category into the prompt template, and appending output format specifications comprising content length and narrative style parameters.

11. The system according to claim 10, wherein the circuitry is configured to receive a user-specified additional condition from the terminal device, append the additional condition to the prompt template as a supplemental constraint, and regenerate the prompt sentence incorporating the supplemental constraint for input to the generative neural network model.

12. The system according to claim 1, wherein the circuitry is configured to store, in a storage device, a history of emotion estimation results, generated content data, and content adjustment actions associated with a user session identifier, and incorporate the stored history as context data in subsequent prompt sentences to improve long-term adaptation of content generation.

13. The system according to claim 12, wherein the circuitry is configured to apply a pattern extraction algorithm to the stored history to identify recurring emotional state transitions, generate a predictive adjustment strategy based on the identified transitions, and pre-generate content data incorporating the predictive adjustment strategy prior to receiving a subsequent emotion estimation result.

14. The system according to claim 1, wherein the circuitry is configured to apply a content quality evaluation algorithm to the generated content data to compute at least one of a readability metric, an age-appropriateness metric, or a coherence metric, and trigger a content regeneration cycle when any of the computed metrics falls below a predetermined quality threshold.

15. The system according to claim 14, wherein the circuitry is configured to generate a quality-improvement prompt sentence incorporating the quality evaluation results, input the quality-improvement prompt sentence to the generative neural network model, and receive regenerated content data satisfying the quality thresholds for transmission to the terminal device.

16. The system according to claim 1, wherein the circuitry is configured to apply a text-to-speech synthesis model to the content data after the content adjustment processing to generate audio story data, and transmit the audio story data together with the content data to the terminal device for synchronized audio-visual presentation.

17. The system according to claim 16, wherein the circuitry is configured to adjust at least one of a speech rate parameter, a pitch parameter, or a prosodic pattern of the audio story data based on the emotion estimation result, and regenerate the audio story data with the adjusted parameters prior to transmission to the terminal device.

18. A system comprising:
circuitry configured to:
receive, via a communication interface coupled to a packet-switched network, request data comprising selection data corresponding to at least one content category and at least one target age range from a terminal device;
extract condition data from the request data, automatically generate a prompt sentence by applying character string processing to the condition data, and input the prompt sentence to a generative neural network model to generate content data comprising story information;
apply an emotion estimation processing unit to the generated content data and to user state data received from the terminal device to estimate an emotional state of a user, and perform content adjustment processing modifying story components or an expression format based on an emotion estimation result; and
transmit the content data after the content adjustment processing to the terminal device.

19. The system according to claim 18, wherein the circuitry is configured to generate an updated prompt sentence incorporating the emotion estimation result as an adjustment condition, input the updated prompt sentence to the generative neural network model to generate updated content data, and transmit the updated content data to the terminal device during an ongoing content delivery session.

20. A method performed by circuitry, the method comprising:
receiving, via a communication interface coupled to a packet-switched network, request data from a terminal device comprising selection data corresponding to at least one content category and at least one target age range;
extracting condition data comprising the content category and the target age range from the request data, and automatically generating, by applying character string processing to the condition data, a prompt sentence expressed in natural language;
inputting the prompt sentence to a generative neural network model and causing the generative neural network model to generate content data comprising story information by performing probabilistic computation based on the prompt sentence;
inputting the generated content data to an emotion estimation processing unit that estimates an emotional state of a user, and performing content adjustment processing for modifying story components or an expression format within the content data based on an emotion estimation result; and
transmitting the content data after the content adjustment processing to the terminal device via the communication interface.
